(19) United States
(12) Patent Application Publication
(10) Pub. No.: US 2024/0152592 A1
(43) Pub. Date: May 9, 2024

(54) AUTHENTICATION TERMINAL, AUTHENTICATION SYSTEM, AUTHENTICATION METHOD, AND NON-TRANSITORY COMPUTER READABLE MEDIUM

(71) Applicant: NEC Corporation, Minato-ku, Tokyo (JP)

(72) Inventors: Mitsuru TOMITA, Tokyo (JP); Daisuke Kawasaki, Tokyo (JP); Kaori Yamane, Tokyo (JP)

(73) Assignee: NEC Corporation, Minato-ku, Tokyo (JP)

(21) Appl. No.: 18/284,096

(22) PCT Filed: Mar. 26, 2021
(86) PCT No.: PCT/JP2021/012869

§ 371 Date: Sep. 26, 2023

(51) Int. Cl. G06F 21/32; G06F 21/36

(52) U.S. Cl. CPC G06F 21/32; G06F 21/36

(57) ABSTRACT

The image acquisition unit acquires a body image generated by capturing an image of a body of a target person when a target person is in a position away from an imaging unit by a first distance and acquires a code image generated by capturing an image of a code recording medium carried by the target person when the target person is in a position away from the imaging unit by a second distance shorter than the first distance. The authentication information generation unit starts processing for generating biometric information for authentication of the target person from the body image in accordance with the acquisition of the body image of the target person. The embedded information acquisition unit acquires embedded information from the code image. The authentication unit executes biometric authentication by collating biometric information for authentication with biometric information for registration included in the embedded information.

### TECHNICAL FIELD

The present disclosure relates to an authentication terminal, an authentication system, an authentication method, and a non-transitory computer readable medium.

### BACKGROUND ART

Authentication systems in which authentication is carried out with a simple configuration without storing personal information regarding a living body in a database have been proposed.

For example, Patent Literature 1 discloses an authentication system in which authentication of a user is performed by collating facial feature points extracted from a captured image of a user with facial feature points read out from an information code using an information code such as a two-dimensional information code in which facial feature points of a user are recorded.

Further, Patent Literature 2 discloses a personal authentication system in which personal authentication is carried out by collating data of feature points of a palm print recorded in a two-dimensional code with data of feature points of a palm print detected from image data of a palm of a person to be authenticated.

### CITATION LIST

### Patent Literature

[Patent Literature 1] International Patent Publication No. WO 2020/149339
[Patent Literature 2] Japanese Unexamined Patent Application Publication No. 2001-256501

### SUMMARY OF INVENTION

### Technical Problem

In the methods disclosed in the aforementioned Patent Literature 1 and 2, however, there is a problem that throughput of authentication is insufficient since processing for extracting biometric information from a captured image has a high load and time consuming.

In view of the aforementioned problem, an object of the present disclosure is to provide an authentication terminal, an authentication system, an authentication method, and a non-transitory computer readable medium capable of improving throughput of authentication.

### Solution to Problem

An authentication terminal according to one aspect of the present disclosure includes: image acquisition means for acquiring a body image generated by capturing an image of a body of a target person when the target person is in a position located away from imaging means by a first distance and acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded; authentication information generation means for starting, in accordance with the acquisition of the body image of the target person, processing for generating biometric information for authentication of the target person from the body image; embedded information acquisition means for acquiring the embedded information from the code image in accordance with the acquisition of the code image; authentication means for executing biometric authentication by collating the biometric information for authentication with the biometric information for registration included in the embedded information; and gate control means for preventing the target person from passing through a gate when the biometric authentication has failed.

An authentication system according to one aspect of the present disclosure includes an authentication terminal including: image acquisition means for acquiring a body image generated by capturing an image of a body of a target person when the target person is in a position located away from imaging means by a first distance and acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded; authentication information generation means for starting, in accordance with the acquisition of the body image of the target person, processing for generating biometric information for authentication of the target person from the body image; embedded information acquisition means for acquiring the embedded information from the code image in accordance with the acquisition of the code image; authentication means for executing biometric authentication by collating the biometric information for authentication with the biometric information for registration included in the embedded information; and gate control means for preventing the target person from passing through a gate when the biometric authentication has failed.

An authentication method according to one aspect of the present disclosure includes: a first image acquisition step of acquiring a body image generated by capturing an image of a body of a target person when the target person is in a position located away from imaging means by a first distance; an authentication information generation step of starting processing for generating biometric information for authentication of the target person from the body image in accordance with the acquisition of the body image of the target person; a second image acquisition step of acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded; an embedded information acquisition step of acquiring the embedded information from the code image in accordance with the acquisition of the code image; an authentication step of executing biometric authentication by collating the biometric information for authentication with the biometric information for registration included in the embedded information; and a gate control step of preventing the target person from passing through a gate when the biometric authentication has failed.

A non-transitory computer readable medium according to one aspect of the present disclosure stores a program for causing a computer to execute: first image acquisition processing for acquiring a body image generated by capturing an image of a body of a target person when the target person is in a position located away from imaging means by a first distance; authentication information generation processing for starting, in accordance with the acquisition of the body image of the target person, processing for generating biometric information for authentication of the target person from the body image; second image acquisition processing for acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded; embedded information acquisition processing for acquiring the embedded information from the code image in accordance with the acquisition of the code image; authentication processing for executing biometric authentication by collating the biometric information for authentication with the biometric information for registration included in the embedded information; and gate control processing for preventing the target person from passing through a gate when the biometric authentication has failed.

### Advantageous Effects of Invention

According to the present disclosure, it is possible to provide an authentication terminal, an authentication system, an authentication method, and a non-transitory computer readable medium capable of improving throughput of authentication.

### BRIEF DESCRIPTION OF DRAWINGS

FIG. 1 is a block diagram showing a configuration of an authentication terminal according to a first example embodiment;

FIG. 2 is a flowchart showing a flow of an authentication method according to the first example embodiment;

FIG. 3 is a block diagram showing a whole configuration of an authentication system according to a second example embodiment;

FIG. 4 is a diagram for describing an outline of a flow of face authentication;

FIG. 5 is a diagram showing one example of a data configuration of embedded information;

FIG. 6 is a block diagram showing a configuration of a management apparatus according to the second example embodiment;

FIG. 7 is a block diagram showing a configuration of a code generation terminal according to the second example embodiment;

FIG. 8 is a flowchart showing a flow of a code generation method according to the second example embodiment;

FIG. 9 is a block diagram showing a configuration of an authentication terminal according to the second example embodiment;

FIG. 10 is a flowchart showing a flow of an authentication method according to the second example embodiment;

FIG. 11 is a diagram for describing an authentication method according to a third example embodiment;

FIG. 12 is a diagram for describing one example of a condition under which face information extraction processing according to the third example embodiment is started;

FIG. 13 is a flowchart showing a flow of a part of the authentication method according to the third example embodiment;

FIG. 14 is a block diagram showing a configuration of an authentication terminal according to a fourth example embodiment;

FIG. 15 is a diagram showing one example of a data structure of prevention condition information according to the fourth example embodiment;

FIG. 16 is a flowchart showing a flow of an authentication method according to the fourth example embodiment;

FIG. 17 is a block diagram showing a configuration of an authentication terminal according to a fifth example embodiment;

FIG. 18 is a diagram showing one example of an output of the authentication terminal according to the fifth example embodiment;

FIG. 19 is a diagram showing one example of an output of an authentication terminal according to a modified example of the fifth example embodiment;

FIG. 20 is a block diagram showing a whole configuration of an authentication system according to a sixth example embodiment;

FIG. 21 is a block diagram showing a configuration of a management apparatus according to the sixth example embodiment;

FIG. 22 is a block diagram showing a configuration of a code generation terminal according to the sixth example embodiment;

FIG. 23 is a flowchart showing a flow of a code generation method according to the sixth example embodiment;

FIG. 24 is a block diagram showing a configuration of an authentication terminal according to the sixth example embodiment;

FIG. 25 is a flowchart showing a flow of an authentication method according to the sixth example embodiment;

FIG. 26 is a block diagram showing a whole configuration of an authentication system according to a seventh example embodiment;

FIG. 27 is a block diagram showing a whole configuration of an authentication system according to an eighth example embodiment; and

FIG. 28 is a block diagram showing a configuration of an authentication terminal according to the eighth example embodiment.

### EXAMPLE EMBODIMENT

In the following, with reference to the drawings, example embodiments of the present disclosure will be described in detail. Throughout the drawings, the same or corresponding elements are denoted by the same symbols. For the sake of clarification of the description, the overlapping descriptions are partially omitted and simplified as appropriate.

### First Example Embodiment

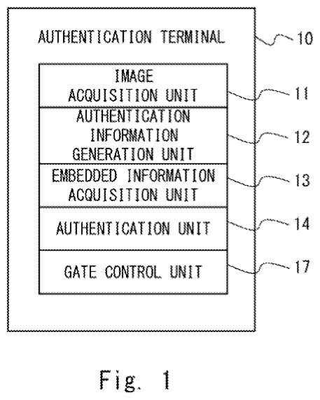

First, a first example embodiment of the present disclosure will be described. FIG. 1 is a block diagram showing a configuration of an authentication terminal 10 according to the first example embodiment. The authentication terminal 10 is an information processing terminal that executes biometric authentication using a code recording medium carried by a target person. The code recording medium includes a code symbol. The code symbol, which is an information code that can be visually recognized, may be a two-dimensional code such as barcode or QR Code (registered trademark), or a color barcode such as Chameleon Code (registered trademark). Embedded information at least including biometric information for registration of a target person is recorded in the code symbol. The biometric information is feature information of a face, fingerprints, iris, ear, or vein. The identification information of the target person, which is information for identifying the target person, is also called a target person ID.

The authentication terminal 10 is connected to a gate drive apparatus of a gate by wirelessly or by a wire in such a way that they can communicate with each other. The gate may be a gate that a target person wants to pass through.

The authentication terminal 10 includes an image acquisition unit 11, an authentication information generation unit 12, an embedded information acquisition unit 13, an authentication unit 14, and a gate control unit 17.

The image acquisition unit 11 is also referred to as image acquisition means. The image acquisition unit 11 acquires a body image generated by capturing an image of a body of a target person and a code image generated by capturing an image of a code recording medium. The body of the target person to be captured, which is at least a part of the body of the target person, is, for example, the face, a finger, an eye, an ear, or a palm of the target person. The aforementioned body image is generated by capturing an image of the body of the target person when the target person is away from an imaging unit (not shown) by a first distance. Further, the aforementioned code image is generated by capturing a code recording medium when the target person is away from the imaging unit by a second distance. The second distance is shorter than the first distance. That is, when the user U is approaching the imaging unit, the image of the body of the user U is captured first, and then the image of the code recording medium carried by the user U is captured.

The authentication information generation unit 12 is also referred to as authentication information generation means. The authentication information generation unit 12 starts processing for generating biometric information for authentication of the target person from the body image in accordance with the acquisition of the body image of the target person.

The embedded information acquisition unit 13 is also referred to as embedded information acquisition means. The embedded information acquisition unit 13 acquires embedded information from the code image acquired by the image acquisition unit 11. Specifically, the embedded information acquisition unit 13 extracts a code symbol from the code image, and performs decode processing on the code symbol, thereby acquiring the embedded information.

The authentication unit 14 is also referred to as authentication means. The authentication unit 14 executes biometric authentication by collating the biometric information for registration included in the embedded information acquired from the code image by the embedded information acquisition unit 13 with the biometric information for authentication generated based on the body image.

The gate control unit 17 is also referred to as gate control means. When the biometric authentication has failed, the gate control unit 17 prevents the target person from passing through the gate. The case where the biometric authentication has failed indicates a case where the biometric information for registration does not match the biometric information for authentication. The case where these biometric information items do not math each other includes a case where the degree of match between these biometric information items is smaller than a predetermined threshold.

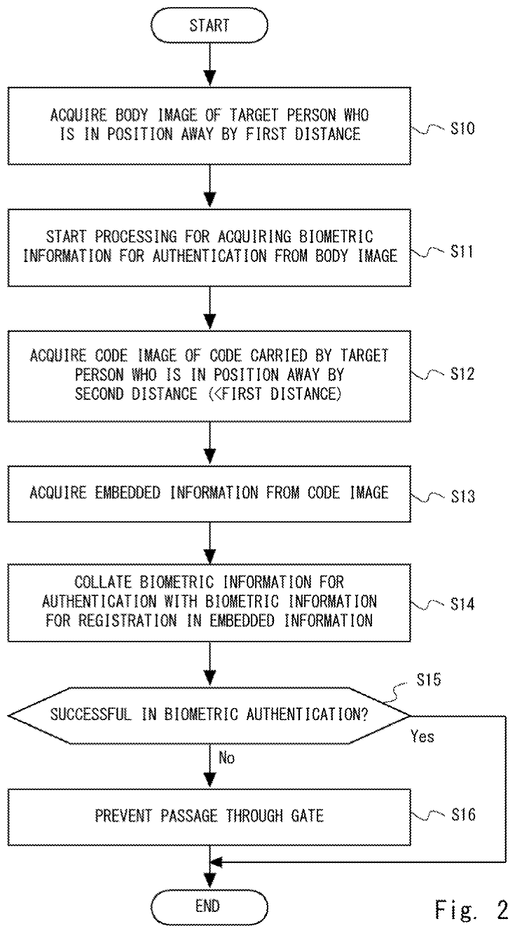

FIG. 2 is a flowchart showing a flow of an authentication method according to the first example embodiment. First, the image acquisition unit 11 of the authentication terminal 10 acquires a body image generated by capturing an image of a body of a target person when the target person is in a position away from the imaging unit by a first distance (S10). Next, the authentication information generation unit 12 starts processing for generating biometric information for authentication of the target person from the body image (S11). Next, the image acquisition unit 11 acquires a code image generated by capturing an image of a code recording medium carried by the target person when the target person is in a position away from the imaging unit by a second distance (S12). Next, the embedded information acquisition unit 13 acquires embedded information from the code image in accordance with the acquisition of the code image (S13). Next, the authentication unit 14 collates biometric information for authentication with biometric information for registration included in the embedded information, thereby executing biometric authentication (S14). Next, the authentication unit 14 determines whether or not biometric authentication has been successful (S15). When the authentication unit 14 determines that biometric authentication has been successful (Yes in S15), the processing is ended. On the other hand, when the authentication unit 14 determines that biometric authentication has failed (No in S15), the gate control unit 17 prevents the target person from passing through the gate (S16).

As described above, according to the first example embodiment, the authentication terminal 10 captures an image of the body of the target person prior to capturing an image of the code recording medium, and starts processing for acquiring biometric information for authentication from the body image. Accordingly, the authentication terminal 10 is able to perform processing for acquiring biometric information for authentication while the target person is coming close to the imaging unit, which improves the throughput of the authentication.

Note that the authentication terminal 10 includes a processor, a memory, and a storage apparatus as components that are not shown. Further, a computer program in which processing of the authentication method according to this example embodiment is implemented is stored in the storage apparatus. Then, this processor causes a computer program to be loaded into the memory from the storage apparatus and executes this computer program. Accordingly, the processor implements the functions of the image acquisition unit 11, the authentication information generation unit 12, the embedded information acquisition unit 13, the authentication unit 14, and the gate control unit 17.

Alternatively, each of the image acquisition unit 11, the authentication information generation unit 12, the embedded information acquisition unit 13, the authentication unit 14, and the gate control unit 17 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as a processor.

Further, when some or all of the components of the authentication terminal 10 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the authentication terminal 10 may be provided in the form of Software as a Service (SaaS).

### Second Example Embodiment

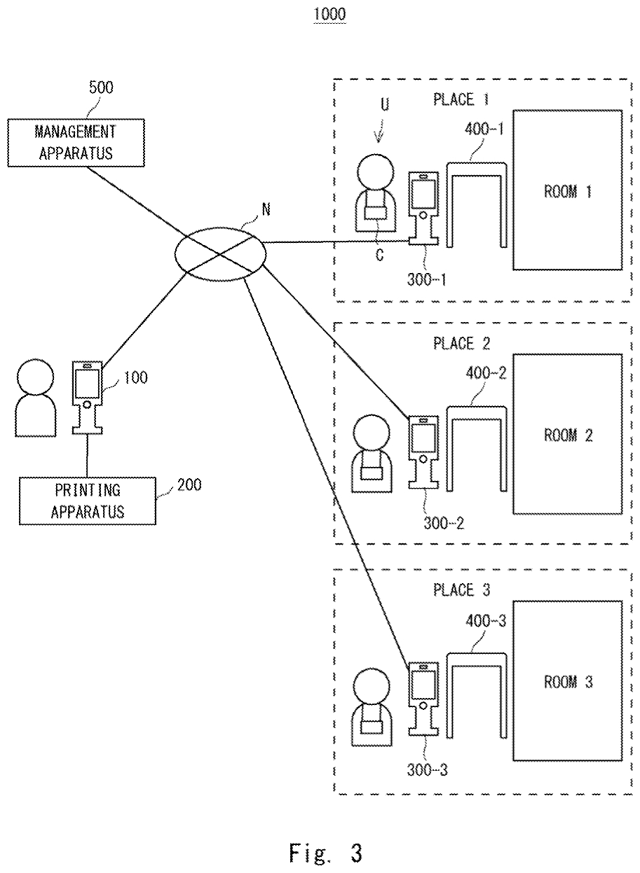

Next, a second example embodiment according to the present disclosure will be described. FIG. 3 is a block diagram showing the whole configuration of an authentication system 1000 according to the second example embodiment. The authentication system 1000 is a computer system that executes biometric authentication using a code recording medium C carried by a user U, who is a target person. In the following, a case where face authentication is executed as biometric authentication will be described as an example, but it is only one example. Further, the following description will be given based on the assumption that the code recording medium C is a printed object obtained by printing a code symbol on paper or plastic. For example, the user U inserts, for example, the code recording medium C into a card case with a neck strap, and wears this neck strap around his/her neck, and thereby carrying the code recording medium C. However, this is merely an example and the code recording medium C may be a smartphone, a tablet terminal or the like that is carried by the user U and displays a code symbol.

The authentication system 1000 includes a code generation terminal 100, a printing apparatus 200, authentication terminals 300-1 to 300-3, gates 400-1 to 400-3, and a management apparatus 500. At least the code generation terminal 100, the authentication terminals 300-1 to 300-3, and the management apparatus 500 are connected to one another via a network N. The network N is a wired or wireless communication line.

The code generation terminal 100 is an information processing terminal that generates a code symbol. The code generation terminal 100 is, for example, a tablet terminal, a smartphone, or a personal computer (PC). First, the code generation terminal 100 captures an image of the face of a user U, and acquires, from the face image generated by imaging, face information for registration of the user U. In one example, the face information may be a set of feature points extracted from the face image and may be referred to as face feature information. Then, the code generation terminal 100 generates embedded information at least including face information for registration of the user U and identification information of the user U (user ID), and converts the embedded information into a code symbol that can be visually recognized. The code generation terminal 100 outputs the information on the code symbol after the conversion to the printing apparatus 200. The code generation terminal 100 may not be connected to the network N.

The printing apparatus 200 is a printing apparatus that is connected to the code generation terminal 100 in such a way that they can communicate with each other by a wire or wirelessly. When the code generation terminal 100 is connected to the network N, the printing apparatus 200 may also be connected to the network N or the code generation terminal 100 and the printing apparatus 200 may be peer-to-peer connected to each other via Bluetooth (registered trademark) or the like. The printing apparatus 200 prints the information on the code symbol received from the code generation terminal 100 on the code recording medium C.

The gates 400-1 to 400-3 are respectively gates for permitting users to enter or preventing users from entering the rooms 1 to 3. The gates 400-1 to 400-3, which are opening/closing bodies for permitting the users to enter or leave from the rooms 1 to 3, may be, for example, doors. Each of the rooms 1 to 3 may be a confidential area where only authorized personnel are allowed to enter and leave. In the following, the gates 400-1, 400-2, and 400-3 may be simply referred to as a gate 400 when it is not necessary to differentiate among them. The gate 400 includes a gate drive apparatus that drives opening and closing of the gate.

The authentication terminals 300-1 to 300-3 are respectively installed at places 1 to 3 near the gates 400-1 to 400-3. In the following, the authentication terminals 300-1, 300-2, and 300-3 may be simply referred to as an authentication terminal 300 when it is not necessary to differentiate among them. Note that, in FIG. 3, each of the number of authentication terminals 300 and the number of gates 400 is three, each of the number of authentication terminals 300 and the number of gates 400 may be two or smaller, or may be four or larger.

The authentication terminal 300 is an information processing terminal that executes face authentication using the code recording medium C carried by the user U. The authentication terminal 300 is, for example, a tablet terminal, a smartphone, or a PC.

For example, in order to enter the room 2, the user U visits the authentication terminal 300-2 and receives face authentication by the authentication terminal 300-2. Then, when the face authentication has been successful, the authentication terminal 300-2 opens the gate 400-2 that corresponds to the authentication terminal 300-2. On the other hand, when the face authentication has failed, the authentication terminal 300-2 closes the gate 400-2. Note that the opening of the gate 400-2 may include unlocking of the gate 400-2, and closing of the gate 400-2 may include locking of the gate 400-2. Further, the authentication terminal 300-2 transmits the results of the face authentication to the management apparatus 500 along with the user ID.

Specifically, first, the authentication terminal 300-2 captures an image of the face of the user U, and acquires face information for authentication of the user U from the face image generated by capturing the image. Further, the authentication terminal 300-2 captures an image of the code recording medium C carried by the user U, and acquires the embedded information from the code image generated by capturing the image. Then, the authentication terminal 300-2 collates the face information for authentication with the face information for registration included in the embedded information, thereby executing face authentication. When the face authentication has been successful, the authentication terminal 300-2 transmits an open control signal to the gate drive apparatus of the corresponding gate 400-2 to allow the user U to pass through the gate. That is, the authentication terminal 300-2 allows the user U to enter or leave the room 2. On the other hand, when the face authentication has failed, the authentication terminal 300-2 transmits a close control signal to the gate drive apparatus of the corresponding gate 400-2 and prevents the user U from passing through the gate 400-2. That is, the authentication terminal 300-2 prohibits the user U from entering or leaving the room 2. Further, the authentication terminal 300-2 transmits the results of the face authentication including information that face authentication has been successful, the user ID included in the embedded information, and the date and time of the authentication (the date and time of imaging) to the management apparatus 500 via the network N. The results of the face authentication may include, besides the aforementioned ones, information on the place where the authentication terminal 300-2 is installed or identification information on the gate 400-2. The results of the face authentication function as information for managing the date and time of the attendance of the user U and the date and time of entering or leaving. While the processing of the authentication terminal 300-2 has been described above, the same holds true for the authentication terminals 300-1 and 300-3 as well.

Note that the authentication terminal 300 may not necessarily control the opening and closing of the gate 400. For example, an authentication terminal 300 that does not perform opening/closing control of the gate 400 and is installed to manage only the attendance date and time may be provided. In this case, the user U visits the authentication terminal 300 when he/she starts working and ends working, and is subject to face authentication by the authentication terminal 300.

The management apparatus 500 manages the results of the face authentication of the user U who has visited the authentication terminal 300 as a face authentication history. Then, the management apparatus 500 manages the attendance of the user U and the history of entering the rooms 1 to 3 or the history of leaving from the rooms 1 to 3 based on the face authentication history of the user U.

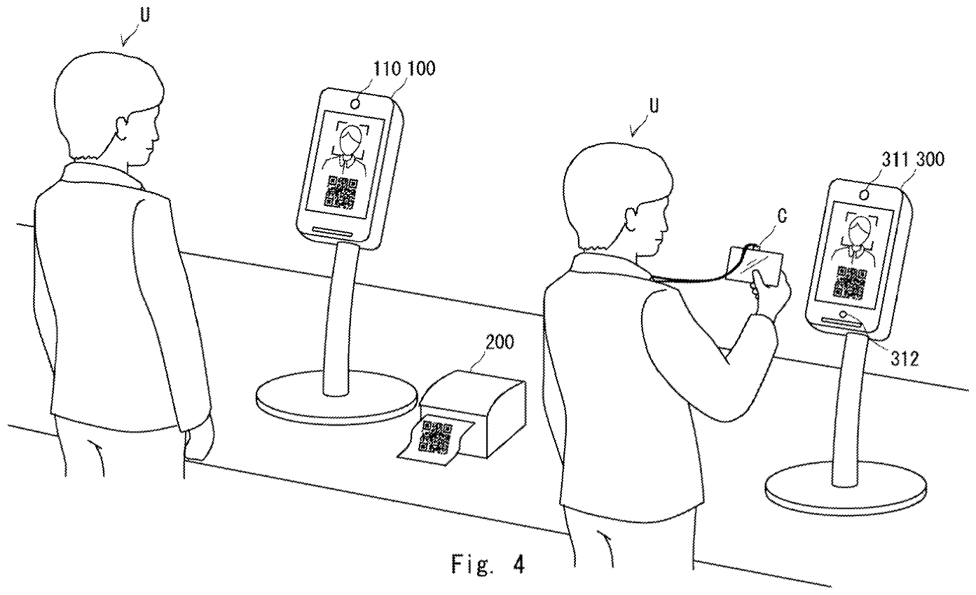

FIG. 4 is a diagram for describing an outline of a flow of face authentication. First, the user U visits the code generation terminal 100 in order to generate a code symbol. The code generation terminal 100 captures an image of the face of the user U by the camera 110 and generates a code symbol in accordance with the face image generated by capturing the image. Then, the code generation terminal 100 transmits the generated information on the code symbol to the printing apparatus 200 to cause the printing apparatus 200 to print this information on the code recording medium C (in FIG. 4, paper). The user U carries the code recording medium C on which the code symbol is printed by putting the code recording medium C into, for example, a card case with a neck strap. Then, the user U approaches the corresponding authentication terminal 300 and holds the code recording medium C over the authentication terminal 300 when he/she starts working, when he/she enters or leaves the room, and when he/she ends working.

The authentication terminal 300 captures an image of the face of the user U by the first camera 311, captures an image of the code recording medium C by the second camera 312, and executes face authentication. When the face authentication has been successful, the authentication terminal 300 transmits the user ID included in the embedded information acquired by reading out the code symbol of the code recording medium C to the management apparatus 500 to cause the management apparatus 500 to open the gate 400. On the other hand, when the face authentication has failed, the authentication terminal 300 causes the management apparatus 500 to close the gate 400. The first camera 311 and the second camera 312 are provided at any different positions on a main surface of the body of the authentication terminal 300. While the first camera 311 is provided in an upper part of the authentication terminal 300 and the second camera 312 is provided in a lower part of the authentication terminal 300 in FIG. 4, the first camera 311 may be provided in a lower part of the authentication terminal 300 and the second camera 312 may be provided in an upper part of the authentication terminal 300. Further, the first camera 311 and the second camera 312 may be provided on the left side and the right side of the authentication terminal 300, respectively, or may be provided on the right side and the left side of the authentication terminal 300, respectively.

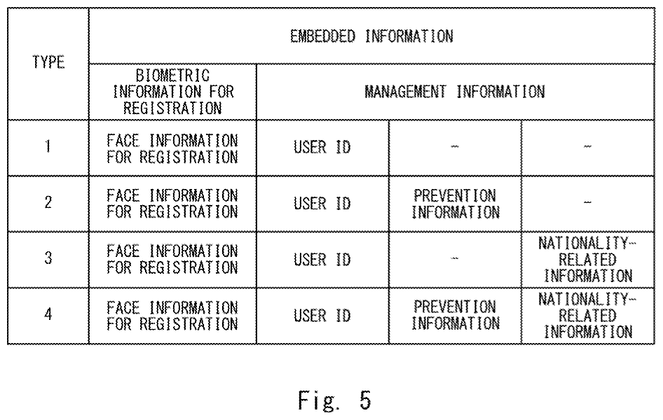

Now, the embedded information indicated by the code symbol of the code recording medium C will be described. FIG. 5 is a diagram showing one example of a data configuration of the embedded information. The embedded information includes biometric information for registration and management information that is used for information processing performed by the authentication terminal 300. The biometric information for registration included in the embedded information in FIG. 5, which is face information for registration, indicates data configurations of the embedded information of types 1 to 4 whose management information items are different from one another.

The embedded information of the type 1 includes a user ID as management information.

The embedded information of the type 2 includes a user ID and prevention information as management information. The prevention information is information that is used to determine whether or not to prevent the user U from passing through the gate 400. Alternatively, the prevention information is information that is used to determine whether or not to execute biometric authentication regarding passage through the gate 400. The prevention information may be, for example, validity period information indicating the validity period of the code symbol, available place information indicating the place where the code symbol can be used, or an in-house attribute information indicating an in-house attribute of the user U. The in-house attribute may be a type of employment, a department, or a position.

The embedded information of the type 3 includes a user ID and nationality-related information as management information. The nationality-related information is information related to the nationality of the user U, the national origin of the user U, or the language used by the user U (this language may hereinafter referred to as a used language).

The embedded information of the type 4 includes a user ID, prevention information, and nationality-related information as management information.

Now, a case where the embedded information is the type 1 will be described in the second example embodiment and a third example embodiment. The cases where the embedded information is of the types 2, 3, and 4 will be described in a fourth example embodiment, a fifth example embodiment, and a modified example of the fifth example embodiment, respectively.

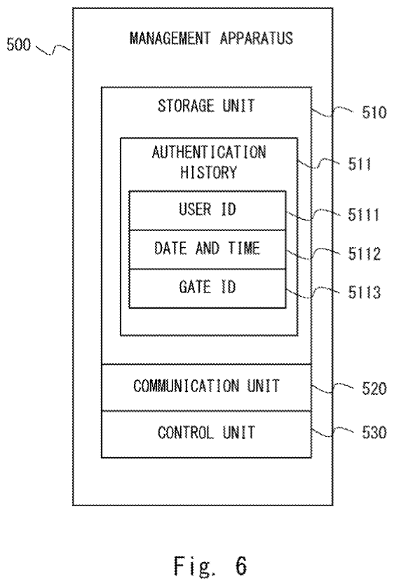

FIG. 6 is a block diagram showing a configuration of a management apparatus 500 according to the second example embodiment. The management apparatus 500 includes a storage unit 510, a communication unit 520, and a control unit 530.

The storage unit 510 is a storage apparatus that stores an authentication history 511. The authentication history 511, which indicates a history of face authentication by the authentication terminal 300, is information in which a user ID 5111, date and time 5112, and a gate ID 5113 are associated with one another. The user ID 5111 is information that is included in the notification sent from the authentication terminal 300 and identifies the user U who has been successful in face authentication. The date and time 5112 may be date and time of face authentication (date and time of imaging) included in the notification of the results of the face authentication from the authentication terminal 300 or may be the date and time when the notification has been received. The gate ID 5113 is information for identifying the gate 400 associated with the authentication terminal 300 that has sent the notification. The gate ID 5113 may be information (position information) indicating the place where the authentication terminal 300 that has sent the notification is installed, or information (position information) indicating the place where the gate 400 associated with the authentication terminal 300 is installed. Then, the storage unit 510 stores, besides the authentication history 511, a program for implementing each function of the management apparatus 500.

The communication unit 520 is a communication interface with the network N. The control unit 530 controls hardware included in the management apparatus 500. When the control unit 530 has received the results of the face authentication from the authentication terminal 300, the control unit 530 stores the user ID, the date and time, and the gate ID included in the notification in the storage unit 510 as the authentication history 511.

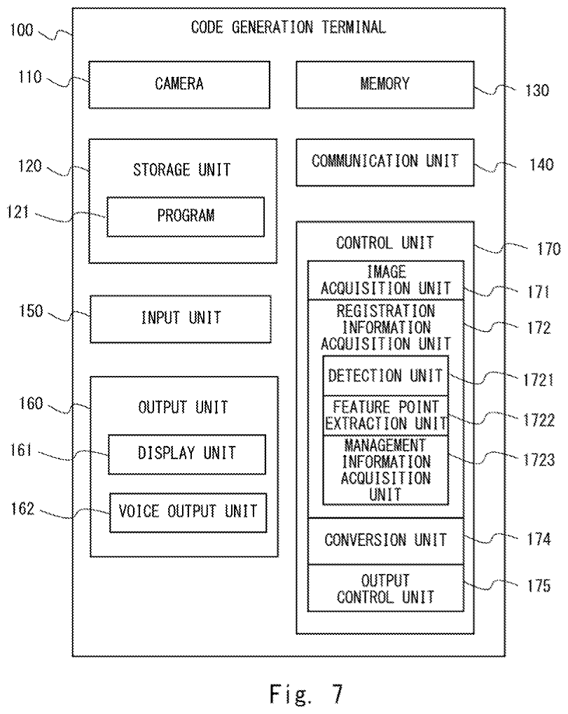

FIG. 7 is a block diagram showing a configuration of the code generation terminal 100 according to the second example embodiment. The code generation terminal 100 includes a camera 110, a storage unit 120, a memory 130, a communication unit 140, an input unit 150, an output unit 160, and a control unit 170.

The camera 110 is an image-capturing apparatus that captures images in accordance with the control performed by the control unit 170. The storage unit 120 is a storage apparatus that stores a program 121 for implementing each function of the code generation terminal 100. The memory 130, which is a volatile storage apparatus such as a Random Access Memory (RAM), is a storage area for temporarily holding information when the control unit 170 operates. The communication unit 140 is a communication interface with the network N. Further, the communication unit 140 may also function as a communication interface with the printing apparatus 200. The input unit 150 is an input device that receives the input.

The output unit 160 outputs the results of information processing in the control unit 170. The output unit 160 includes, for example, a display unit 161 and a voice output unit 162. The display unit 161 is a display device that displays the results of information processing in the control unit 170. The display unit 161 and the input unit 150 may each be integrally configured like, for example, a touch panel. The voice output unit 162, which includes a speaker, outputs the results of information processing in the control unit 170 by voice.

The control unit 170 is a processor that controls each component of the code generation terminal 100, that is, a control apparatus. The control unit 170 causes the program 121 to be loaded to the memory 130 from the storage unit 120 to execute the loaded program 121. Accordingly, the control unit 170 implements the functions of an image acquisition unit 171, a registration information acquisition unit 172, a conversion unit 174, and an output control unit 175.

The image acquisition unit 171 is also referred to as image acquisition means. The image acquisition unit 171 controls the camera 110 in such a way that the camera 110 captures an image of the face of the user U to generate a face image for registration including at least this face region of the user U. Then, the image acquisition unit 171 acquires the face image for registration from the camera 110. The image acquisition unit 171 supplies the face image for registration to the registration information acquisition unit 172.

The registration information acquisition unit 172 is also referred to as registration information acquisition means. The registration information acquisition unit 172 acquires the face information for registration of the user U from the face image for registration. Further, the registration information acquisition unit 172 acquires management information on the user U. For example, the registration information acquisition unit 172 acquires the user ID, which is the management information of the user U, via the input unit 150. At this time, the input unit 150 may receive a manual input from the user U or another operator, or receive the input by reading out an information medium such as a barcode in which the management information is recorded. Further, the registration information acquisition unit 172 may acquire the user ID by newly issuing the user ID when it acquires the face image of the user U. Here, the registration information acquisition unit 172 includes a detection unit 1721, a feature point extraction unit 1722, and a management information acquisition unit 1723.

The detection unit 1721 is also referred to as detection means. The detection unit 1721 detects a face region included in the face image for registration and supplies the detected face region to the feature point extraction unit 1722.

The feature point extraction unit 1722 is also referred to as feature point extraction means. The feature point extraction unit 1722 extracts feature points from the face region detected by the detection unit 1721 and supplies information on the extracted feature points to the conversion unit 174 as the face information for registration.

The management information acquisition unit 1723 is also referred to as management information acquisition means. The management information acquisition unit 1723 acquires management information such as a user ID received from the user U by the input unit 150. However, the management information acquisition unit 1723 may newly issue the user ID when the code symbol is generated. Then the management information acquisition unit 1723 supplies the management information to the conversion unit 174.

The conversion unit 174 is also referred to as conversion means. The conversion unit 174 converts the embedded information including the face information for registration and the management information of the user U into a code symbol that can be visually recognized. For example, the conversion unit 174 converts the embedded information into a QR code symbol (QR code). The conversion into the code symbol may be conversion of composite information in which the face information for registration is combined with the management information into a code symbol. Further, the code symbol may be generated by converting a part of the embedded information (e.g., face information for registration) into a parent code symbol and replacing a part of the parent code symbol by the remaining part of the embedded information (e.g., management information). Note that the conversion unit 174 may convert the embedded information into a code symbol after encrypting the embedded information. Accordingly, it is possible to improve the security level. At this time, the conversion unit 174 may encrypt a part of the embedded information and may not encrypt another part of the embedded information. For example, the conversion unit 174 may encrypt the face information for registration and may not encrypt the management information, or may encrypt the management information and may not encrypt the face information for registration.

The output control unit 175 is also referred to as output control means. The output control unit 175 outputs the information on the code symbol converted by the conversion unit 174 to the printing apparatus 200 via the communication unit 140. Accordingly, a code symbol indicating the embedded information can be printed on the code recording medium C.

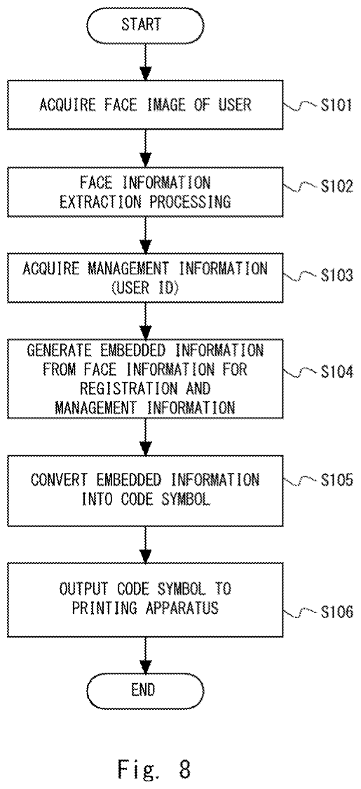

FIG. 8 is a flowchart showing a flow of a code generation method according to the second example embodiment. First, the image acquisition unit 171 of the code generation terminal 100 controls the camera 110 to capture an image of the face of the user U, and acquires the face image for registration of the user U generated by capturing the image (S101). Next, the registration information acquisition unit 172 executes face information extraction processing for extracting face information from the face image for registration of the user U (S102). Specifically, the detection unit 1721 of the registration information acquisition unit 172 detects the face region included in the face image for registration of the user U, and the feature point extraction unit 1722 extracts feature points from the detected face region, which are used as the face information for registration. The registration information acquisition unit 172 supplies the face information for registration to the conversion unit 174. Next, the management information acquisition unit 1723 of the registration information acquisition unit 172 acquires the user ID, which is the management information, via the input unit 150 (S103). At this time, the input unit 150 may receive a manual input from the user U or another operator, or may receive the input by reading out the information medium in which the management information is recorded. Note that the management information acquisition unit 1723 may instead newly issue a user ID. The management information acquisition unit 1723 supplies the management information (in this example, a user ID) to the conversion unit 174. Next, the conversion unit 174 generates embedded information based on the face information for registration and the management information (S104). The conversion unit 174 may convert the face information for registration and management information into one information item by combining them. Alternatively, the generation of the embedded information may be specifying face information for registration as first embedded information and management information as second embedded information. Next, the conversion unit 174 converts the embedded information into a code symbol (S105). At this time, the conversion unit 174 may convert the embedded information into a code symbol using an existing technique. For example, the conversion unit 174 may convert the composite information of the face information for registration and the management information into a code symbol. Further, the conversion unit 174 may convert the first embedded information (face information for registration) and an error correction code into a code symbol, and replace some of the blocks of the code symbol by blocks in which second embedded information is embedded. Then, the output control unit 175 outputs the information on the code symbol after the conversion to the printing apparatus 200 (S106).

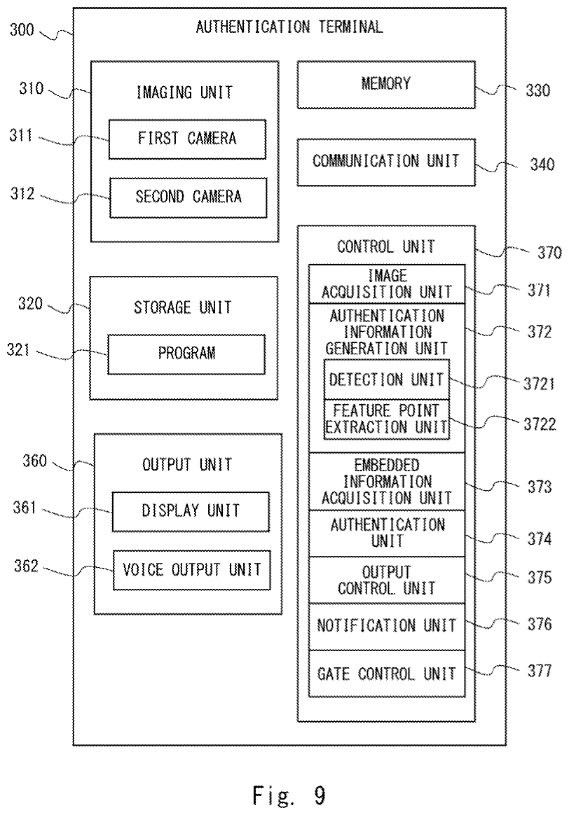

FIG. 9 is a block diagram showing a configuration of an authentication terminal 300 according to the second example embodiment. The authentication terminal 300 includes an imaging unit 310, a storage unit 320, a memory 330, a communication unit 340, an output unit 360, and a control unit 370.

The imaging unit 310 is also referred to as imaging means. The imaging unit 310 captures images in accordance with the control performed by the control unit 370. The imaging unit 310 includes a first camera 311 and a second camera 312. The first camera 311 captures an image of the face of the user U in accordance with the control performed by the control unit 370. The second camera 312 captures an image of the code recording medium C carried by the user U in accordance with the control performed by the control unit 370.

The storage unit 320 is a storage apparatus that stores a program 321 for implementing each function of the authentication terminal 300. The memory 330, which is a volatile storage apparatus such as a RAM, is a storage area for temporarily holding information when the control unit 370 operates. The communication unit 340 is a communication interface with the network N.

The output unit 360 outputs the results of information processing in the control unit 370. For example, the output unit 360 includes a display unit 361 and a voice output unit 362. The display unit 361 is a display device that displays the results of information processing in the control unit 370. Note that the authentication terminal 300 may include an input unit (not shown) that receives the input, and the display unit 361 and the input unit may be integrally formed as a touch panel. The voice output unit 362, which includes a speaker, outputs the results of information processing in the control unit 370 by voice.

The control unit 370 is a processor that controls each component of the authentication terminal 300, that is, a control apparatus. The control unit 370 causes a program 321 to be loaded to the memory 330 from the storage unit 320 and executes the loaded program 321. Accordingly, the control unit 370 implements the functions of an image acquisition unit 371, an authentication information generation unit 372, an embedded information acquisition unit 373, an authentication unit 374, an output control unit 375, a notification unit 376, and a gate control unit 377.

The image acquisition unit 371 is also called image acquisition means. The image acquisition unit 371 controls the first camera 311 of the imaging unit 310 to cause the first camera 311 to capture an image of the face of the user U, thereby generating a face image for authentication at least including the face region of the user U. The image acquisition unit 371 acquires the face image for authentication from the first camera 311. Further, the image acquisition unit 371 controls the second camera 312 of the imaging unit 310 to cause the second camera 312 to capture an image of the code recording medium C carried by the user U, thereby generating a code image. Then, the image acquisition unit 371 acquires the code image from the second camera 312. The image acquisition unit 371 supplies the face image for authentication to the authentication information generation unit 372 and supplies the code image to the embedded information acquisition unit 373.

The authentication information generation unit 372 is also referred to as authentication information generation means. The authentication information generation unit 372 generates face information for authentication of the user U from the face image for authentication. The authentication information generation unit 372 includes a detection unit 3721 and a feature point extraction unit 3722. The detection unit 3721 and the feature point extraction unit 3722 may respectively perform processing similar to those of the detection unit 1721 and the feature point extraction unit 1722 of the code generation terminal 100. That is, the detection unit 3721 detects a face region included in the face image for authentication and supplies the detected face region to the feature point extraction unit 3722. The feature point extraction unit 3722 extracts feature points from the face region detected by the detection unit 3721 and supplies information on the extracted feature points to the authentication unit 374 as face information for authentication.

The embedded information acquisition unit 373 is also referred to as embedded information acquisition means. The embedded information acquisition unit 373 extracts a code symbol from the code image acquired by the image acquisition unit 371 and performs decode processing on the code symbol, thereby acquiring the embedded information. The embedded information acquisition unit 373 supplies the embedded information to the authentication unit 374.

The authentication unit 374 is also referred to as authentication means. The authentication unit 374 executes face authentication by collating the face information for registration included in the embedded information, the face information for registration acquired in the embedded information acquisition unit 373, with the face information for authentication generated by the authentication information generation unit 372. The authentication unit 374 notifies the output control unit 375, the notification unit 376, and the gate control unit 377 of a result indicating whether or not these face information items match each other. The result indicating whether or not the face information items match each other corresponds to whether or not the authentication has been successful or failed. It is assumed that the face information items matching each other (match) means a case where the degree of match is equal to or larger than a predetermined value.

The output control unit 375 is also referred to as output control means. The output control unit 375 controls the output unit 360, causes the output unit 360 to output the results of information processing, and notifies the user U of the results of information processing. For example, the output control unit 375 causes the output unit 360 to output the results of the face authentication and notifies the user U of the results of the face authentication.

The notification unit 376 is also referred to as notification means. When the results of the face authentication indicates that the face information items match each other, that is, face authentication has been successful, the notification unit 376 extracts a user ID from the embedded information and sends the results of the face authentication and the user ID to the management apparatus 500 via the network N. Note that the user ID may be included in the results of the face authentication.

The gate control unit 377 is also referred to as gate control means. The gate control unit 377 allows the user U to pass through the gate 400 or prohibits the user U from passing through the gate 400 in accordance with the results of the face authentication. For example, the gate control unit 377 transmits a control signal in accordance with the results of the face authentication to the gate drive apparatus of the gate 400 at a place where an image of the user U is captured. In one example, when face information items match each other, that is, when face authentication has been successful, the gate control unit 377 transmits a control signal (open control signal) indicating that the gate 400 will be opened to the gate drive apparatus to allow the user U to pass through the gate 400. On the other hand, when face information items do not match each other, that is, when face authentication has failed, the gate control unit 377 transmits a control signal indicating that the gate 400 will be closed to the gate drive apparatus to prevent the user U from passing through the gate 400. Note that the control signal transmitted from the gate control unit 377 may be a control signal for outputting information indicating that face authentication has been successful or failed, or information indicating that the passage through the gate 400 is permitted or prohibited to the gate drive apparatus instead of a control signal indicating that the gate will be opened or closed.

While the entry/exit of the user U can be managed by the gate control unit 377, the gate control unit 377 may not be absolutely necessary. That is, an authentication terminal 300 that does not include the gate control unit 377 may be provided.

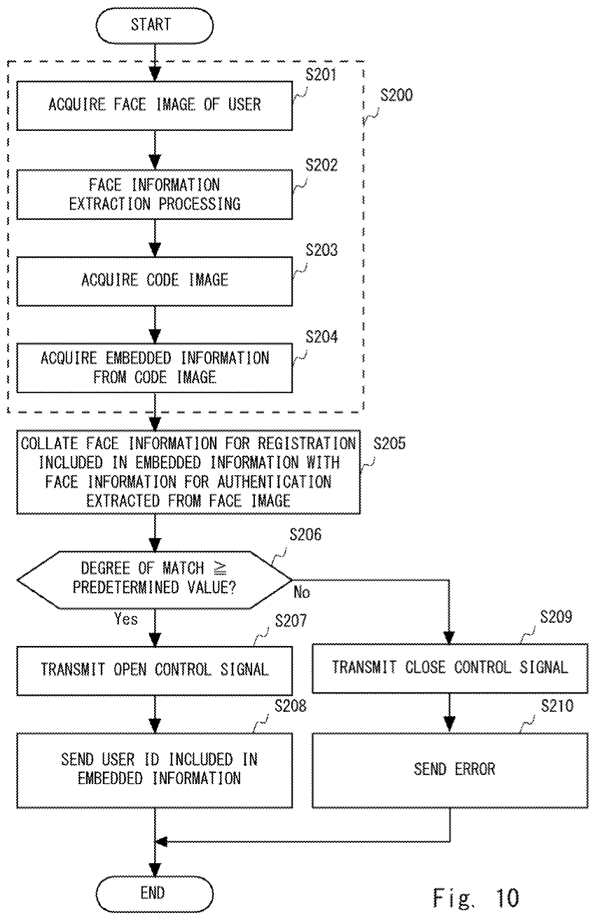

FIG. 10 is a flowchart showing a flow of an authentication method according the second example embodiment. First, the authentication terminal 300 executes processing shown in Step S200. In the second example embodiment, Step S200 corresponds to processing in which the authentication terminal 300 generates face information for authentication to acquire embedded information, and includes Steps S201 to 204. First, the image acquisition unit 371 of the authentication terminal 300 controls the first camera 311 of the imaging unit 310 to cause the first camera 311 to capture an image of the face of the user U, thereby acquiring the face image for authentication (Step S201). Next, the authentication information generation unit 372 executes face information extraction processing for extracting face information from the face image for authentication of the user U (Step S202). Specifically, the detection unit 3721 of the authentication information generation unit 372 detects a face region included in the face image for authentication of the user U, and the feature point extraction unit 3722 extracts feature points from the detected face region, which are used as face information for authentication. The authentication information generation unit 372 supplies the face information for authentication to the authentication unit 374. Next, the image acquisition unit 371 controls the second camera 312 of the imaging unit 310 to cause the second camera 312 to capture an image of the code recording medium C carried by the user U, thereby acquiring a code image (Step S203). Next, the embedded information acquisition unit 373 extracts a code symbol from the code image, performs decoding processing on the code symbol, thereby acquiring the embedded information (S204). The embedded information acquisition unit 373 supplies the embedded information to the authentication unit 374.

Note that, in the second example embodiment, Steps S203 and 204 may be executed before Steps S201 and S202 or may be performed in parallel to Steps S201 and S202.

Next, the authentication unit 374 collates the face information for registration included in the embedded information with the face information for authentication extracted from the face image (S205). When these face information items match each other, that is, when the degree of match between these face information items is equal to or larger than a predetermined value (Yes in S206), the authentication unit 374 supplies information indicating that the face information items match each other to the gate control unit 377 and supplies the user ID included in the embedded information to the notification unit 376, and proceeds the processing to Step S207. In Step S207, the gate control unit 377 transmits an open control signal to the gate drive apparatus of the gate 400 that corresponds to the authentication terminal 300 (S207). Accordingly, the gate 400 opens, which allows the user U to pass through the gate 400. At this time, the output control unit 375 may send information indicating that the face authentication has been successful to the user U by causing the output unit 360 to display information indicating that the face authentication has been successful or causing the output unit 360 to output this information by voice. Next, in Step S208, the notification unit 376 transmits a notification that at least includes a user ID and indicates that the face authentication has been successful to the management apparatus 500 via the network N. Note that the notification unit 376 may include, besides the user ID, the date and time of face authentication (date and time of imaging) and the gate ID in this notification.

On the other hand, when the face information items do not match each other, that is, when the degree of match between these face information items is smaller than the predetermined value (No in S206), the authentication unit 374 supplies information indicating that the face information items do not match each other to the gate control unit 377 and the notification unit 376 and proceeds the processing to Step S209. In Step S209, the gate control unit 377 transmits a close control signal to the gate drive apparatus of the gate 400 that corresponds to the authentication terminal 300 (S209). At this time, the output control unit 375 may notify the user U that the face authentication has failed by causing the output unit 360 to display information indicating that the face authentication has failed or causing the output unit 360 to output this information by voice. Next, in Step S210, the notification unit 376 transmits information indicating that the face authentication has failed to the management apparatus 500 via the network N as an error notification. While the notification unit 376 may include the user ID included in the embedded information in the error notification, it is only one example.

As described above, according to the second example embodiment, the authentication terminal 300 is able to check whether or not the owner of the code recording medium C matches the person to be photographed and identify the person to be photographed without recording the biometric information in the DB. Accordingly, it is possible to prevent spoofing while reducing system management costs. This brings a significant effect in an industry, in particular, where a number of workers are often replaced by other workers. Further, since the authentication system 1000 does not need to manage biometric information, the security risk such as an information leakage can be reduced. Further, since the printing of a code symbol on a code recording medium C such as a paper can be easily carried out without requiring any special apparatus, the operation cost can be reduced. Further, the authentication system 1000 is highly convenient since, even when the user U loses the code recording medium C, the code recording medium C can be easily reissued by generating a code signal and printing the generated code signal on the code recording medium C.

Then, the authentication terminal 300 notifies the management apparatus 500 of the user ID of the user U who has been successful in biometric authentication, whereby it is possible to simplify the management of the biometric authentication history and easily manage attendance records and entry/exit records based on the biometric authentication history. Accordingly, it is possible to easily avoid unauthorized attendance registration and unauthorized entry/exit by workers.

### Third Example Embodiment

Next, a third example embodiment according to the present disclosure will be described. In the aforementioned second example embodiment, the processing in which the authentication terminal 300 acquires a face image and generates face information for authentication (Steps S201 and S202 in FIG. 10) and the processing of acquiring a code image and acquiring embedded information (Steps S203 and S204 in FIG. 10) may be performed in any order. However, the processing for generating the face information for authentication, which includes processing for extracting face information, has a high load. Therefore, if a face image is acquired to extract face information after the user U reaches the authentication terminal 300, a waiting time may occur until authentication processing is completed. On the other hand, according to the third example embodiment, the authentication terminal 300 starts to perform the processing of acquiring the face image to extract face information prior to the processing for acquiring the code image and acquiring embedded information. Since the authentication system 1000 according to the third example embodiment includes the components that are similar to those of the authentication system 1000 according to the second example embodiment, the descriptions thereof will be omitted. While the part of the body to be biometrically authenticated is a face in the third example embodiment as well, it is only one example.

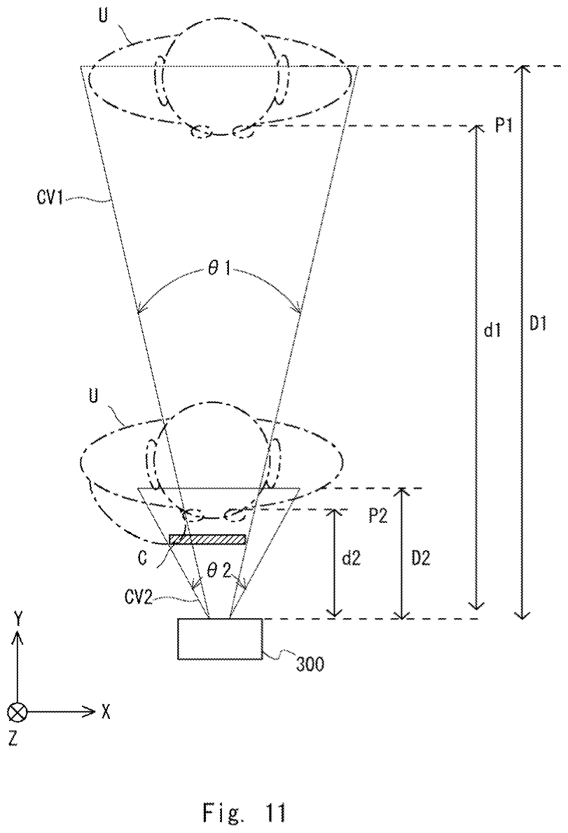

FIG. 11 is a diagram for describing an authentication method according to the third example embodiment. In FIG. 11, the right-left direction of the user U is denoted by an X-axis direction, the height direction of the user U is denoted by an Z-axis direction, and the front-back direction of the user U is denoted by a Y-axis direction. Note that the optical axis direction of the first camera 311 of the imaging unit 310 and the optical axis direction of the second camera 312 of the imaging unit 310 may substantially match each other, and may be substantially match the Y-axis direction. That is, the optical axis direction of the imaging unit 310 may substantially match the Y-axis direction.

The capture volume CV1 shown in FIG. 11 is a region where the first camera 311 of the imaging unit 310 of the authentication terminal 300 is able to capture an image of the face region of the user U for face authentication. The distance that is the farthest from the imaging surface of the first camera 311 in the Y-axis direction in the capture volume CV1 is referred to as a first maximum distance D1. Further, the angle of view of the first camera 311 is set to a first angle of view θ1.

Further, the capture volume CV2 is a region in which the second camera 312 of the imaging unit 310 of the authentication terminal 300 is able to capture an image of the code recording medium C for face authentication. Here, the distance that is the farthest from the imaging surface of the second camera 312 in the Y-axis direction in the capture volume CV2 is referred to as a second maximum distance D2. The second maximum distance D2 is set so as to be shorter than the first maximum distance D1. Note that the imaging surface of the second camera 312 in the Y-axis direction may substantially match the imaging surface of the first camera 311. Further, the angle of view of the second camera 312 is set to a second angle of view θ2.

The first camera 311 captures a “face image for authentication” by receiving a control performed by the image acquisition unit 371 of the control unit 370 in accordance with detection of the user U in the capture volume CV1. That “the first camera 311 captures a” face image for authentication“in accordance with detection of the user U in the capture volume CV1” may mean one of the following cases A1 to A3.

In the case A1, only when the first camera 311 has detected the user U in the capture volume CV1, the captured image is supplied to the image acquisition unit 371. In this case, the image acquisition unit 371 may specify all the captured images supplied from the first camera 311 as “face images for authentication”. Then, the authentication information generation unit 372 starts processing for extracting face information.

In the case A2, the first camera 311 continually captures images at predetermined time intervals and supplies the captured images to the image acquisition unit 371, and only when the first camera 311 has detected a user U in the capture volume CV1, the image acquisition unit 371 supplies the captured image to the authentication information generation unit 372 as a “face image for authentication”. That is, in the case A2, the image acquisition unit 371 acquires a plurality of captured images generated by the first camera 311 capturing images a plurality of times and supplies at least one of the plurality of captured images to the authentication information generation unit 372 as a “face image for authentication”. Accordingly, the authentication information generation unit 372 starts to perform processing for extracting face information of a “face image for authentication”.

In the case A3, the first camera 311 continually captures images at predetermined time intervals and continually supplies the captured images generated by capturing to the authentication information generation unit 372 via the image acquisition unit 371. In this case, the authentication information generation unit 372 specifies the supplied captured image as a “face image for authentication” in accordance with detection of the user U in the capture volume CV1, and starts processing for extracting face information of a “face image for authentication”. That is, in the case A3, the image acquisition unit 371 acquires a plurality of captured images generated by the first camera 311 capturing images a plurality of times, and the authentication information generation unit 372 generates biometric information for authentication by setting at least one of the plurality of captured images as a “face image for authentication”.

While “the first camera 311 capturing a” face image for authentication “in accordance with detection of the user U in the capture volume CV1” will be defined below by the meaning of the case A3, it is only one example.

Here, the position of the user U when a “face image for authentication” is captured by the first camera 311 is referred to as a position P1, and the distance from the imaging surface of the first camera 311 to the position P1 in the optical axis direction of the first camera 311 will be referred to as a first distance d1. The first distance d1 may be the same as the first maximum distance D1 or may be shorter than the first maximum distance D1.

The second camera 312 captures a “code image for authentication” by receiving a control performed by the image acquisition unit 371 of the control unit 370 in accordance with detection of a code recording medium C carried by the user U in the capture volume CV2. Note that “the second camera 312 capturing a “code image for authentication” in accordance with detection of a code recording medium C carried by the user U in the capture volume CV2” may mean one of the following cases B1 to B3.

In the case B1, only when the second camera 312 has detected a code recording medium C in the capture volume CV2, the captured image is supplied to the image acquisition unit 371. In this case, the image acquisition unit 371 may specify all the captured images supplied from the second camera 312 as “code images for authentication”. Then, the embedded information acquisition unit 373 starts processing for acquiring embedded information.

In the case B2, the second camera 312 continually captures images at predetermined time intervals and supplies these images to the image acquisition unit 371, and only when the code recording medium C is detected in the capture volume CV2, the image acquisition unit 371 supplies the captured image to the embedded information acquisition unit 373 as a “code image for authentication”. Accordingly, the embedded information acquisition unit 373 starts to perform processing for acquiring embedded information.

In the case B3, the second camera 312 continually captures images at predetermined time intervals and the captured images are continually supplied to the image acquisition unit 371 and the embedded information acquisition unit 373. In this case, the embedded information acquisition unit 373 specifies the captured image from the second camera 312 as a “code image for authentication” in accordance with detection of the code recording medium C in the capture volume CV2 and starts processing for acquiring embedded information.

In the following, while “the second camera 312 capturing a “code image for authentication” in accordance with detection of a code recording medium C carried by the user U in the capture volume CV2” is defined by the meaning of the case B3, it is only one example.

Here, the position of the user U when the “code image for authentication” is captured by the second camera 312 is referred to as a position P2 and the distance from the imaging surface of the second camera 312 to the position P2 in the optical axis direction of the second camera 312 is referred to as a second distance d2. The second distance d2 may be the same as the second maximum distance D2 or may be shorter than the second maximum distance D2.

In FIG. 11, the second distance d2 at the position P2 is shorter than the first distance d1 at the position P1. Accordingly, first, the image acquisition unit 371 of the authentication terminal 300 acquires, when the user U is in a position P1 that is away from the imaging unit 310 by a first distance d1, a face image of the user U generated by capturing an image of the face region of the user U by the first camera 311, and supplies the acquired face image to the authentication information generation unit 372. Then, the authentication information generation unit 372 starts the processing for generating the face information for authentication from the face image in accordance with the acquisition of the face image. Accordingly, the authentication information generation unit 372 is able to perform the processing for generating the face information for authentication while the user U is approaching. Further, the image acquisition unit 371 acquires, when the user U is in a position P2 that is away from the imaging unit 310 by the second distance d2, a code image generated by capturing, by the second camera 312, an image of the code recording medium C carried by the user U and supplies the acquired code image to the embedded information acquisition unit 373. Then, the embedded information acquisition unit 373 starts processing for acquiring embedded information from the code image in accordance with the acquisition of the code image. According to the process procedure as described above, it is possible to avoid occurrence of a waiting time for authentication processing and improve the throughput.

Note that the second angle of view θ2 of the second camera 312, that is, the second angle of view θ2 in a case where an image of the code recording medium C is captured may be set to be wider than the first angle of view θ1 of the first camera 311, that is, the first angle of view θ1 when an image of the face (body) of the user U is captured. Note that this is merely an example, and the second angle of view θ2 may be the same as or narrower than the first angle of view θ1.

Here, the condition under which it is determined that the user U has been detected in the capture volume CV1 may also be referred to as a condition under which face information extraction processing of a “face image for authentication” is started.

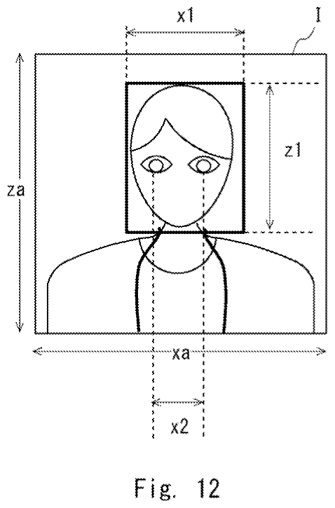

FIG. 12 is a diagram for describing one example of the condition under which the face information extraction processing is started (a condition for detecting the user U in the capture volume CV1) according to the third example embodiment. FIG. 12 shows a captured image I captured by the first camera 311. The captured image I includes a face region of the user U. For example, the condition under which the face information extraction processing is started may be a condition that the size, the width, or the length of the face region of the user U included in the captured image I captured by the first camera 311 is equal to or larger than a predetermined number of pixels. Upon receiving the captured image I from the image acquisition unit 371, the authentication information generation unit 372 detects a face region. Then, the authentication information generation unit 372 determines whether or not the width x1 or the length z1 of the face region is equal to or larger than a predetermined number of pixels. When the width x1 or the length z1 is equal to or larger than a predetermined number of pixels, the authentication information generation unit 372 starts face information extraction processing of a “face image for authentication”. Note that a total number of pixels of the image captured by the first camera 311 (length za×width xa) is determined in advance. Therefore, determining whether or not the width x1 or the length z1 is equal to or larger than a predetermined number of pixels is the same as determining whether or not the width x1 with respect to the width xa of the captured image is equal to or larger than a predetermined value or determining whether or not the length z1 with respect to the length za of the captured image is equal to or larger than a predetermined value.

Accordingly, only when the size of the face region is sufficiently large, face information for authentication is generated by face information extraction processing. Therefore, processing efficiency is improved, and thereby throughput may be improved.

Alternatively, for example, the condition under which the face information extraction processing is started may be a condition that the length of the line connecting feature points of a predetermined face organ included in the face region of the user U included in the image captured by the first camera 311 is equal to or larger than a predetermined number of pixels. The feature points of the face organ may at least two of the right eye, the left eye, end points of the nose, end points of the mouth, end points of the right eyebrow, and end points of the left eyebrow. In one example, the feature points of the face organ are the right eye and the left eye. The authentication information generation unit 372 detects a face region and detects the positions of the right eye and the left eye in the face region. The authentication information generation unit 372 then determines whether or not the length x2 between the right eye and the left eye in the face region is equal to or larger than a predetermined number of pixels. When the length x2 is equal to or larger than the predetermined number of pixels, the authentication information generation unit 372 starts face information extraction processing of a “face image for authentication”. Here, determining whether or not the length x2 is equal to or larger than a predetermined number of pixels is the same as determining whether or not the length x2 with respect to the width xa of the captured image is equal to or larger than a predetermined value.

Accordingly, only when the size of the face region is sufficiently large, face information for authentication is generated by face information extraction processing. Therefore, processing efficiency is improved, and thereby throughput may be improved.

Further, the condition under which the face information extraction processing is started may be a condition that an index of a degree of certainty of an identification of a body calculated from the image captured by the first camera 311 is equal to or larger than a predetermined threshold. The index of the degree of certainty of the identification of the body may be, for example, an index of face-likeness. Accordingly, only when there is a certain likelihood, face information for authentication is generated by the face information extraction processing. Therefore, processing efficiency is improved, and thereby throughput may be improved.

Further, the condition under which the face information extraction processing is started may be a condition that the index of a degree of certainty of an identification of a body calculated from each of the plurality of captured images captured by the first camera 311 in a predetermined period of time has the largest value of the plurality of captured images. Specifically, the authentication control unit 342 calculates an index of a degree of certainty of an identification of a body for each of the plurality of captured images that are captured by the first camera 311 and supplied from the image acquisition unit 371, and selects at least one of the plurality of captured images as the “face image for authentication” based on the index. Accordingly, only when the degree of certainty is relatively high, face information for authentication is generated by face information extraction processing. Therefore, processing efficiency is improved, and thereby throughput may be improved.

Further, when the authentication terminal 300 includes any sensor (e.g., a distance measurement sensor using infrared ray) (not shown) that detects the presence of a person, the condition under which the face information extraction processing is started may be a condition that the sensor has detected that a person is present in the capture volume CV1.

While the conditions under which the face information extraction processing is started (conditions for detecting the user U in the capture volume CV1) have been described above, the starting condition is not limited thereto and may be arbitrarily defined. On the other hand, a condition under which the processing for acquiring embedded information is started (a condition under which the user U is detected in the capture volume CV2) may be arbitrarily defined. For example, the condition under which the processing for acquiring embedded information is started may be a condition that the size, the width, or the length of the image area of the code symbol included in the code image is equal to or larger than a predetermined pixel value. Further, when the authentication terminal 300 includes a sensor such as a distance measurement sensor that detects the presence of a person, the condition under which the processing for acquiring embedded information is started may be a condition that the sensor has detected the presence of a person in the capture volume CV2.

Note that the second camera 312 may not be activated in a normal time and may be activated when a predetermined start condition is satisfied. The predetermined start condition may be a condition that a face region of the user U has been detected from the image captured by the first camera 311. Further, the predetermined start condition may be a condition that the first camera 311 has captured a “face image for authentication”. Further, the predetermined start condition may be a condition that face information extraction processing of a “face image for authentication” by the authentication information generation unit 372 has been started or completed. The processing for starting the second camera 312 may be performed by the image acquisition unit 371. For example, the image acquisition unit 371 may start the second camera 312 in accordance with the acquisition of a “face image for authentication” from the first camera 311 or in accordance with the authentication information generation unit 372 starting or completing the processing for generating the face information for authentication for the “face image for authentication”. In this manner, the second camera 312 is not activated until predetermined processing related to the first camera 311 is executed, whereby it is possible to reduce power consumption and avoid false photographing or false recognition. Then, the second camera 312 may capture an image of the code image in accordance with the activation, and the embedded information acquisition unit 373 may start processing for acquiring embedded information.

Note that the authentication information generation unit 372 may determine whether or not the user U is approaching the imaging unit 310 in response to the condition under which the face information extraction processing is started being met, that is, in accordance with the processing for generating the face information for authentication being started. Specifically, the authentication information generation unit 372 performs, in parallel to the face information extraction processing regarding the face image for authentication, tracking of a person region of the user U included in the captured image captured by the first camera 311 after this timing. The region of the person (person region) to be tracked may be, for example, a face region or an eye region. The authentication information generation unit 372 determines whether or not the user U is approaching the imaging unit 310 based on the difference between the sizes of the person regions of the user U between captured images captured by the first camera 311 after the timing of capturing the specified “face image for authentication”. Then, when the authentication information generation unit 372 has determined that the user U is approaching the imaging unit 310, the authentication information generation unit 372 may cause the embedded information acquisition unit 373 to start processing for acquiring embedded information from the code image for authentication. Alternatively, the authentication information generation unit 372 may cause the authentication unit 374 to execute face authentication (collation) when it has been determined that the user U is approaching the imaging unit 310. Accordingly, it is possible to prevent false recognition of a combination of a code image with a face image. That is, it is possible to prevent the face image from being collated with a code image of the code recording medium C carried by a user other than the user U indicated by the face image.

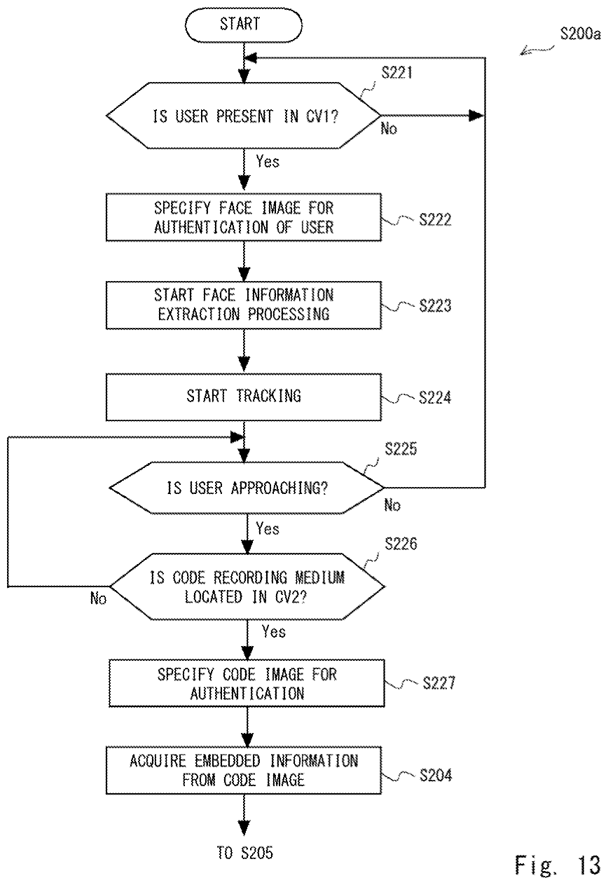

FIG. 13 is a flowchart showing a flow of a part of the authentication method according to the third example embodiment. FIG. 13 shows processing of Step S200a that corresponds to Step S200 shown in FIG. 10. Step S200a is different from Step S200 in that Steps S221 to 227 are included instead of Steps S201 to 203. In FIG. 13, the capturing of an “image for authentication” by the first camera 311 and the capturing of a “code image for authentication” by the second camera 312 are respectively defined by the case A3 and the case B3. That is, all the captured images captured by the first camera 311 at predetermined time intervals are supplied to the authentication information generation unit 372 via the image acquisition unit 371. Further, all the captured images captured by the second camera 312 at predetermined time intervals are supplied to the embedded information acquisition unit 373 via the image acquisition unit 371.

First, the authentication information generation unit 372 of the authentication terminal 300 determines whether or not the user U is present in the capture volume CV1 of the first camera 311 (S221). That is, the authentication information generation unit 372 determines whether or not the condition under which the face information extraction processing is started has been met. When it is determined that the user U is not in the capture volume CV1 of the first camera 311 (No in S221), the authentication information generation unit 372 repeats this processing. On the other hand, when it is determined that the user U is present in the capture volume CV1 of the first camera 311 (Yes in S221), the authentication information generation unit 372 specifies the image captured by the first camera 311 as a “face image for authentication” (S222). Next, the authentication information generation unit 372 starts face information extraction processing for the “face image for authentication” (S223). This step is similar to Step S202 in FIG. 10. Next, the authentication information generation unit 372 starts tracking the user U using the image captured by the first camera 311 after the timing of capturing the specified “face image for authentication” (S224). Then, the authentication information generation unit 372 determines whether or not the user U is approaching the imaging unit 310 (S225). When it is determined that the user U is not approaching the imaging unit 310 (No in S225), the authentication information generation unit 372 returns the processing to Step S221. On the other hand, when it has been determined that the user U is approaching the imaging unit 310 (Yes in S225), the authentication information generation unit 372 proceeds the processing to Step S226.

In Step S226, the embedded information acquisition unit 373 determines whether or not the code recording medium C carried by the user U is located in the capture volume CV2 (S226). When it is determined that the code recording medium C is not located in the capture volume CV2 (No in S226), the embedded information acquisition unit 373 returns the processing to Step S225. On the other hand, when it is determined that the code recording medium C is located in the capture volume CV2 (Yes in S226), the embedded information acquisition unit 373 specifies the image captured by the second camera 312 as the “code image for authentication” (S227). Then, the embedded information acquisition unit 373 acquires embedded information from the “code image for authentication” (S204) and proceeds the processing to Step S205 shown in FIG. 10.

In the aforementioned description, processing for extracting face information of a “face image for authentication” is started in accordance with detection of the user U in the capture volume CV1. However, alternatively, processing for extracting face information may be executed on all the captured images supplied after being captured by the first camera 311, and thereby face information for authentication may be generated. That is, the image acquisition unit 371 may acquire a plurality of pieces of “face images for authentication” generated by the first camera 311 capturing an image of the face of the user U a plurality of times, and the authentication information generation unit 372 may generate face information for authentication of the user U for each of the plurality of pieces of “face images for authentication”. Then, the authentication information generation unit 372 may supply face information for authentication generated as a result of successful processing for extracting face information for face authentication to the authentication unit 374 as the collation target.

As described above, with the authentication terminal 300 according to the third example embodiment, prior to capturing an image of the code recording medium C, processing for capturing an image of the body of the user U and acquiring biometric information for authentication from the body image is started. Accordingly, the authentication terminal 300 is able to perform processing for acquiring biometric information for authentication while the user U is coming close to the imaging unit 310, which improves the throughput of the authentication.

### Fourth Example Embodiment

Next, a fourth example embodiment according to the present disclosure will be described. The fourth example embodiment is a modified example of the second example embodiment. Embedded information indicated by the code symbol of the code recording medium C is embedded information of the type 2. That is, the embedded information includes biometric information for registration, and management information which includes a user ID and prevention information.

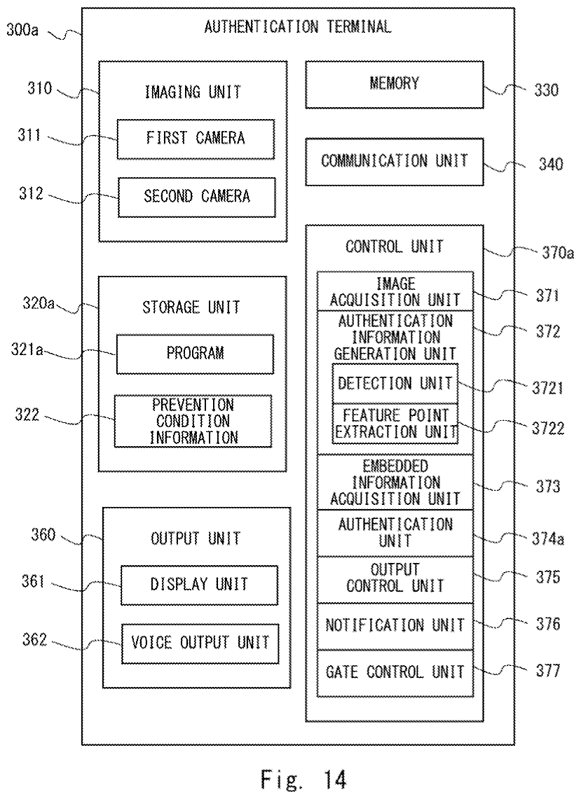

FIG. 14 is a block diagram showing a configuration of an authentication terminal 300a according to the fourth example embodiment. The authentication terminal 300a according to the fourth example embodiment basically includes a configuration and a function similar to those of the authentication terminal 300 according to the first example embodiment. However, the authentication terminal 300a is different from the authentication terminal 300 in that the authentication terminal 300a includes a storage unit 320a and a control unit 370a instead of the storage unit 320 and the control unit 370 included in the authentication terminal 300, respectively. The storage unit 320a stores a program 321a and prevention condition information 322. The program 321a is a computer program in which processing of the authentication method according to the fourth example embodiment is implemented. A condition for preventing a user from passing through the gate 400 (prevention condition) regardless of the results of the face authentication is recorded in the prevention condition information 322. In the fourth example embodiment, the prevention condition may function as a condition for interrupting execution of face authentication when a user passes through the gate 400. This is because, when passing through the gate 400 is prevented regardless of the results of the face authentication, there is little practical benefit in executing face authentication to determine whether or not a user is permitted to pass through the gate 400, and throughput is improved when face authentication is not performed.

The control unit 370a includes an authentication unit 374a instead of the authentication unit 374. The authentication unit 374a executes face authentication when the prevention information does not satisfy a prevention condition indicated by the prevention condition information 322 of the storage unit 320a. On the other hand, when the prevention information satisfies a prevention condition recorded in the prevention condition information 322, the authentication unit 374a interrupts execution of face authentication. In this case, the authentication unit 374a supplies a prevention notification indicating that the execution of the face authentication has been interrupted to the output control unit 375, the notification unit 376, and the gate control unit 377.

The output control unit 375 may output, upon receiving the prevention notification, information indicating that execution of face authentication has been interrupted and information indicating that the passage through the gate 400 has not been permitted to the output unit 360. Further, the notification unit 376 may notify, upon receiving the prevention notification, the management apparatus 500 that the execution of the face authentication has been interrupted and the passage through the gate 400 has not been permitted. Further, the gate control unit 377 may transmit, upon receiving the prevention notification, a control signal for preventing the user U from passing through the gate to a gate drive apparatus of the gate 400.

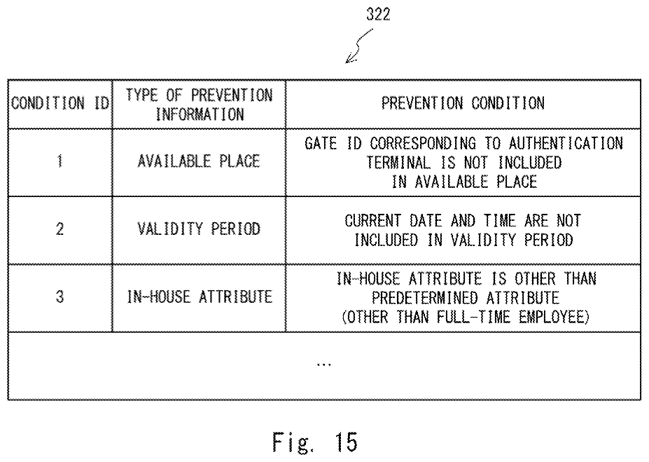

FIG. 15 is a diagram showing one example of a data structure of the prevention condition information 322 according to the fourth example embodiment. The prevention condition information 322 may include one or more prevention conditions. The prevention condition information 322 may be, for example, information in which the type of the prevention information and the prevention condition are associated with each other for each condition ID.

In FIG. 15, the prevention condition of the condition ID “1” is a condition that, when the embedded information includes available place information as prevention information, the gate ID indicating the place where the gate 400 that corresponds to the authentication terminal 300 is installed is not included in the available place indicated by the available place information. Therefore, when the gate ID of the gate 400 that corresponds to the authentication terminal 300 is not included in the available place acquired from the embedded information, the authentication unit 374a interrupts execution of face authentication. Then, the gate control unit 377 controls the gate 400 so as to prevent the user U from passing through the gate 400. Note that the available place may be defined based on the workplace of the user U or the in-house attribute.

Further, the prevention condition of the condition ID “2” is a condition that, when the embedded information includes validity period information as prevention information, the current date and time are not included in the validity period indicated by validity period information. Accordingly, when the current date and time are not included in the validity period, such as expiration of validity, the authentication unit 374a interrupts execution of face authentication. Then, the gate control unit 377 controls the gate 400 so as to prevent the user U from passing through the gate 400. Note that the validity period may be determined based on the labor contract period, working hours, or working days of the user U.

Further, the prevention condition of the condition ID “3” is a condition that, when the embedded information includes in-house attribute information as prevention information, the in-house attribute such as a type of employment, a department, or a position indicated by the in-house attribute information is not a predetermined in-house attribute. In this example, the type of employment indicated by the in-house attribute information is a type of employment other than a full-time employee. Therefore, the authentication unit 374a interrupts execution of face authentication when the in-house attribute information indicates an in-house attribute other than the predetermined in-house attribute. Then, the gate control unit 377 controls the gate 400 so as to prevent the user U from passing through the gate 400.

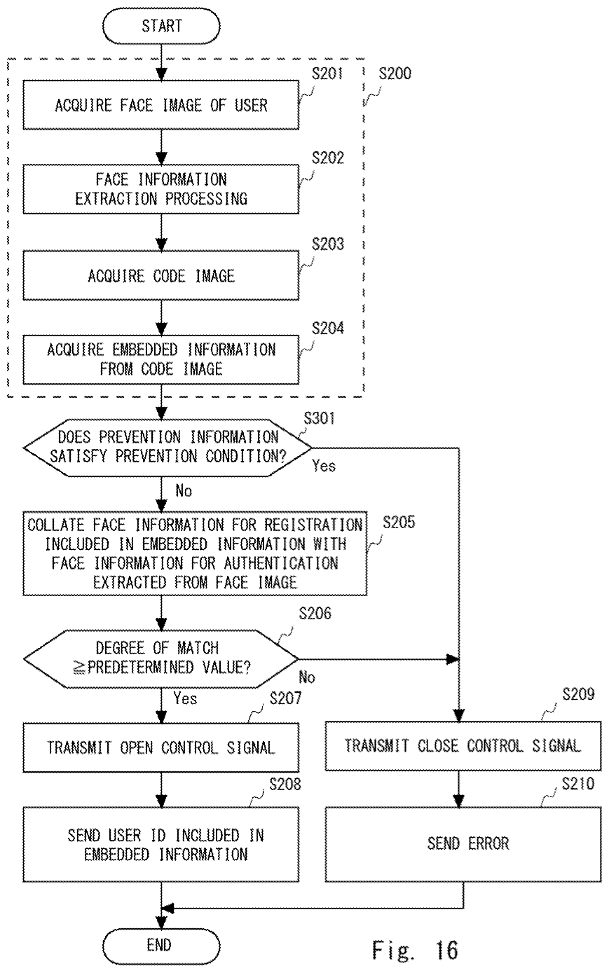

FIG. 16 is a flowchart showing a flow of an authentication method according to the fourth example embodiment. While the steps shown in FIG. 16 are basically similar to those shown in FIG. 10, they are different from each other in that Step S301 is included between Step S204 and Step S205 in FIG. 16.

That is, after the embedded information acquisition unit 373 has acquired embedded information from the code image (S204), the authentication unit 374a determines whether or not the prevention information included in the embedded information satisfies a prevention condition indicated by the prevention condition information 322 (S301). When it is determined that the prevention condition is not satisfied (No in S301), the authentication information generation unit 372a proceeds to the collation processing shown in Step S205. The processing of Step S205 and the following processing are similar to those shown in FIG. 10. On the other hand, when the authentication unit 374a determines that the prevention condition is satisfied (Yes in S301), the gate control unit 377 transmits a close control signal to the gate 400 (S209), and the notification unit 376 transmits an error notification to the management apparatus 500 (S210). However, error notification in this case does not include the user ID.

As described above, according to the fourth example embodiment, the authentication terminal 300a prevents users from passing through the gate 400 using prevention conditions, whereby it is possible to easily prevent persons other than authorized personnel from entering or leaving through the gate. In an industry where a number of workers are often replaced by other workers, in particular, it is normally required to monitor and supervise workers in order to suppress unauthorized entry/exit by workers into rooms. The fourth example embodiment eliminates the monitoring and supervision since the authentication terminal 300a automatically prevents passage.

Further, when the prevention condition is satisfied, the authentication terminal 300a interrupts execution of face authentication, whereby it is possible to avoid unnecessary computations and to improve throughput.

Note that Step S301 may be executed after the face authentication is executed. Specifically, Step S301 may be executed between Yes in Step S206 after it is determined that the face authentication has been successful and Step S207, not between Step S204 and Step S205. In this case, although it is impossible to sufficiently improve throughput, an error notification sent to the management apparatus 500 can include a user ID, whereby it is possible to specify the user U who is committing a wrongdoing.

Note that the steps in a code generation method according to the fourth example embodiment may be similar to the steps shown in FIG. 8. In Step S103, the registration information acquisition unit 172 may acquire, besides the user ID of the user U, prevention information via the input unit 150. At this time, the input unit 150 may receive the manual input by the user U or another operator or the registration information acquisition unit 172 may receive the input by reading out an information medium such as a barcode in which prevention information as well as the user ID is recorded. Alternatively, the registration information acquisition unit 172 may acquire the user ID by newly issuing it when it acquires a face image of the user U and acquire the prevention information via the reception of the manual input by the input unit 150 or reading of the information medium.

### Fifth Example Embodiment

Next, a fifth example embodiment of the present disclosure will be described. The fifth example embodiment is a modified example of the second example embodiment and the embedded information indicated by the code symbol of the code recording medium C is embedded information of the type 3. That is, the embedded information includes biometric information for registration, and management information that includes a user ID and nationality-related information. The nationality-related information is related to the nationality of the user U, the national origin of the user U, or the language used by the user U.

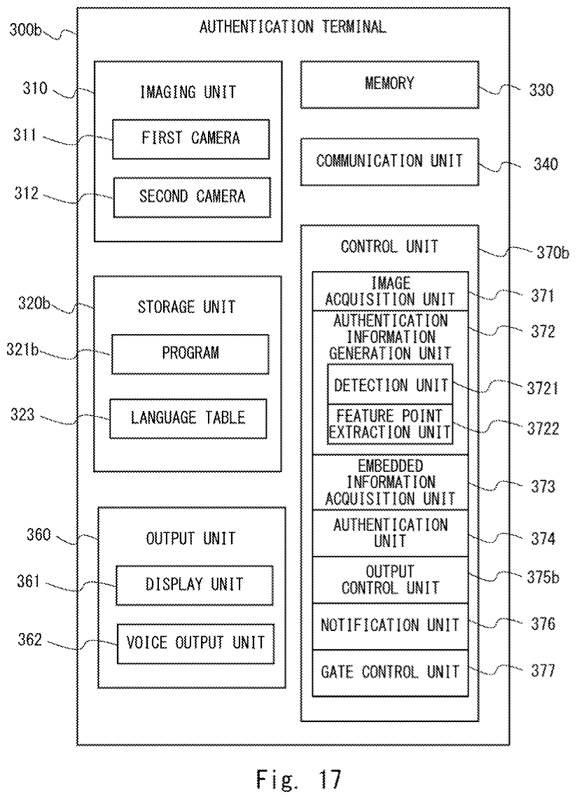

FIG. 17 is a block diagram showing a configuration of an authentication terminal 300b according to the fifth example embodiment. The authentication terminal 300b according to the fifth example embodiment basically includes a configuration and a function similar to those of the authentication terminal 300 according to the first example embodiment. However, the authentication terminal 300b is different from the authentication terminal 300 in that a storage unit 320b and a control unit 370b are included in the authentication terminal 300b instead of the storage unit 320 and the control unit 370 that are included in the authentication terminal 300. The storage unit 320b stores a program 321b and a language table 323. The program 321b is a computer program in which processing of the authentication method according to the fifth example embodiment is implemented. The language table 323 stores display information and voice output information for each language.

The control unit 370b includes an output control unit 375b instead of the output control unit 375. The output control unit 375b causes the output unit 360 to output the results of the face authentication for the user U in the language according to the nationality or the national origin indicated by the nationality-related information, or the used language indicated by the nationality-related information. When the face authentication has failed, the output control unit 375b may cause the output unit 360 to output the reason why the face authentication has failed in the above language.

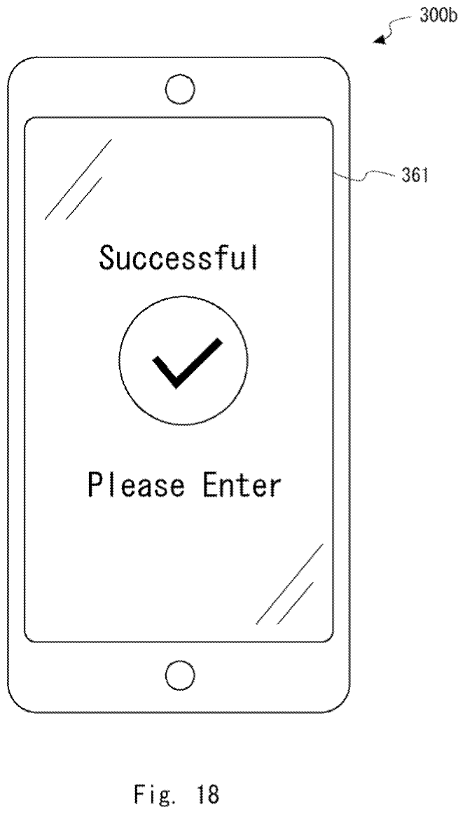

FIG. 18 is a diagram showing one example of the output of the authentication terminal 300b according to the fifth example embodiment. For example, when the embedded information acquired from the code image includes the used language “English” as the nationality-related information, the output control unit 375b of the authentication terminal 300b refers to the display information of English from the language table 323, and causes the display unit 361 to display the results of the face authentication in English. FIG. 18 shows an example of the display when the face authentication information has been successful, and the display unit 361 displays information indicating that the face authentication has been successful and information for letting a user to pass through the gate 400 in English. Further, when the embedded information includes the national origin “America” as the nationality-related information, the language that corresponds to America may be specified as English, the display information of English may be referred to from the language table 323, and the display unit 361 may be caused to display the results of the face authentication in English.

As described above, according to the fifth example embodiment, the authentication terminal 300b outputs the results of the face authentication in the used language of the user U or a language that the user U is likely to use, whereby the user U is able to easily know the results of the face authentication. In industries with a large number of foreign workers, in particular, a significant effect can be obtained.

The steps in a code generation method according to the fifth example embodiment may be similar to the steps shown in FIG. 8. In Step S103, the registration information acquisition unit 172 may acquire, besides the user ID of the user U, nationality-related information via the input unit 150. At this time, the input unit 150 may receive a manual input by the user U or another operator, or the registration information acquisition unit 172 may receive the input by reading out the information medium such as a barcode in which nationality-related information as well as the user ID is recorded. Alternatively, the registration information acquisition unit 172 may acquire the user ID by newly issuing it when the registration information acquisition unit 172 acquires a face image of the user U, and acquire the nationality-related information via the reception of the manual input by the input unit 150 or reading of the information medium.

### Modified Example of Fifth Example Embodiment

Note that the fourth example embodiment and the fifth example embodiment may be combined with each other. In a modified example of the fifth example embodiment, embedded information indicated by the code symbol of the code recording medium C is embedded information of the type 4. That is, the embedded information includes biometric information for registration and management information that includes a user ID, prevention information, and nationality-related information. When the prevention information included in the embedded information has satisfied a prevention condition, the output control unit 375b may cause the output unit 360 to output the reason for the prevention and a countermeasure to the user U in the language according to the nationality-related information.

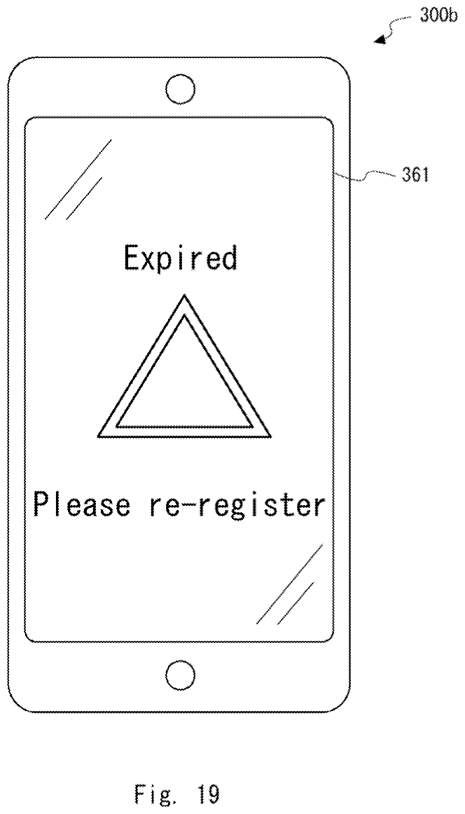

FIG. 19 is a diagram showing one example of output of an authentication terminal 300b according to a modified example of the fifth example embodiment. FIG. 19 shows one example of the display by the display unit 361 in a case where the prevention information has satisfied a prevention condition (expiration of validity) and the nationality-related information included in the embedded information is the used language “English”. The display unit 361 displays information indicating expiration of validity and information for promoting re-registration in English. The information for promoting re-registration means information for promoting re-generation of a code symbol.

As described above, according to the modified example of the fifth example embodiment, the authentication terminal 300b outputs the reason for the prevention and a countermeasure in the used language of the user U or a language that the user U is likely to use, whereby the user U is able to smoothly cope with a situation in which he/she is prevented from passing through the gate. In industries with a large number of foreign workers, in particular, a significant effect can be obtained.

### Sixth Example Embodiment

Next, a sixth example embodiment according to the present disclosure will be described. The sixth example embodiment is a modified example of the second example embodiment. A feature of the sixth example embodiment is that the authentication system selectively uses biometric authentication that uses a code recording medium C or biometric authentication that uses a face information database (DB) depending on user's attributes. The following description uses face authentication as an example of biometric authentication, but it is only one example.

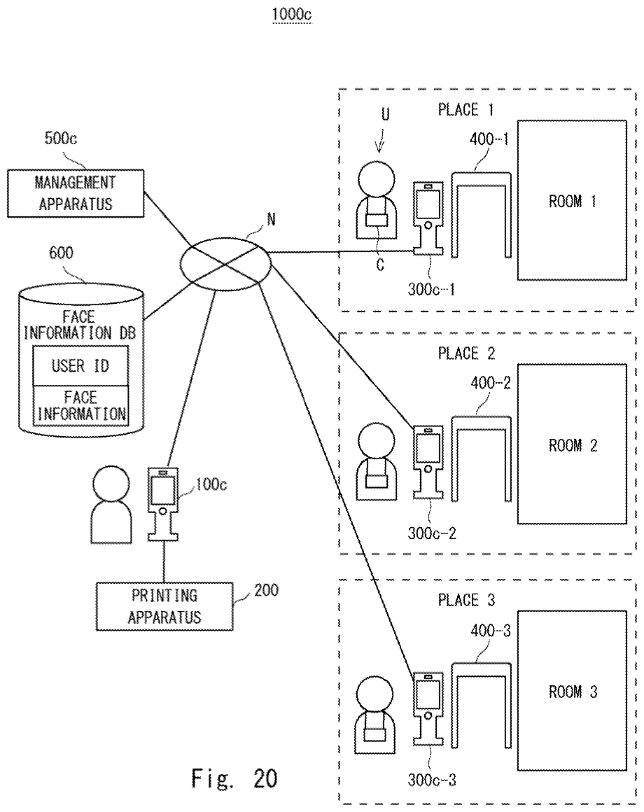

FIG. 20 is a block diagram showing a whole configuration of an authentication system 1000c according to the sixth example embodiment. For example, the authentication system 1000c is a computer system that executes first face authentication using a code recording medium C and second face authentication using a face information DB. In this sixth example embodiment, the user U may be a first user or a second user depending on the user attributes. For example, a part-time worker is a first user and a full-time employee is a second user. The first user carries a code recording medium U in which embedded information including the management information (the user ID) and the face information is recorded, and performs first face authentication using a code recording medium C. The user ID of the first user may be an employee ID of the user. On the other hand, the second user carries an IC card in which the user ID is recorded as the management information, and performs second face authentication using the IC card and a face information DB. The user ID of the second user may be the employee ID of the user or may be the IC card ID that is associated with the employee ID of the user and identifies the IC card. The management information on the second user registered in the IC card may have a data configuration the same as that of the management information shown in FIG. 5. That is, besides the user ID, at least one of the prevention information and the nationality-related information may be recorded as the management information in the IC card. Note that the recording medium in which the management information on the second user is recorded is not limited to an IC card.

The authentication system 1000c includes a code generation terminal 100c, an authentication terminal 300c, a management apparatus 500c, and a face information DB 600 instead of the code generation terminal 100, the authentication terminal 300, and the management apparatus 500 of the authentication system 1000 according to the second example embodiment.

While the code generation terminal 100c includes functions similar to those of the code generation terminal 100 for the first user, the code generation terminal 100c includes a function of registering the face information for registration in the face information DB 600 for the second user.

The authentication terminal 300c includes functions similar to those of the authentication terminal 300 according to the second example embodiment for the first user. However, the authentication terminal 300c reads out the user ID from the IC card, collates the face information for authentication generated from the face image with the face information for registration that is stored in the face information DB 600 and corresponds to the user ID, and executes face authentication for the second user. Note that the authentication terminal 300c performs output control, sends a notification to the management apparatus 500c when face authentication has been successful, and performs gate control for the second user as well, just like for the first user.

The management apparatus 500c manages a face authentication history regarding the first user and a face authentication history regarding the second user. That is, the management apparatus 500c manages the attendance records and a history of entering/leaving from the rooms 1 to 3 by the first user, and the attendance records and a history of entering/leaving from the rooms 1 to 3 by the second user.

The face information DB 600 is a storage apparatus that stores the user ID of the second user in association with face information for registration of the second user.

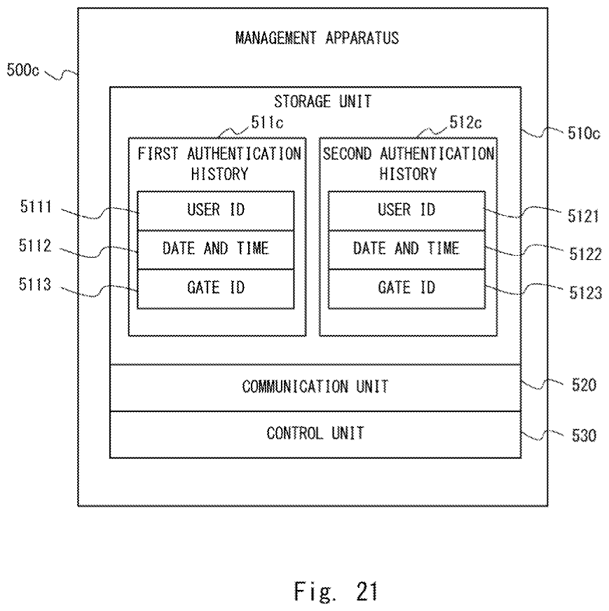

FIG. 21 is a block diagram showing a configuration of the management apparatus 500c according to the sixth example embodiment. The management apparatus 500c includes a storage unit 510c instead of the storage unit 510 of the management apparatus 500.

The storage unit 510c stores a first authentication history 511c and a second authentication history 512c. The first authentication history 511c is a face authentication history regarding the first user and is information in which a user ID 5111, date and time 5112, and a gate ID 5113 are associated with one another, like in the authentication history 511. The second authentication history 512c is a face authentication history of the second user. The second authentication history 512c is information in which a user ID 5121, the date and time 5122, and a gate ID 5123 are associated with one another.

When the control unit 530 has received a notification of the results of the face authentication regarding the first user from the authentication terminal 300c, the control unit 530 records the user ID, the date and time, and the gate ID included in the notification as the first authentication history 511c. On the other hand, when the control unit 530 has received a notification of the results of the face authentication regarding the second user from the authentication terminal 300c, the control unit 530 records the user ID, the date and time, and the gate ID included in the notification as the second authentication history 512c.

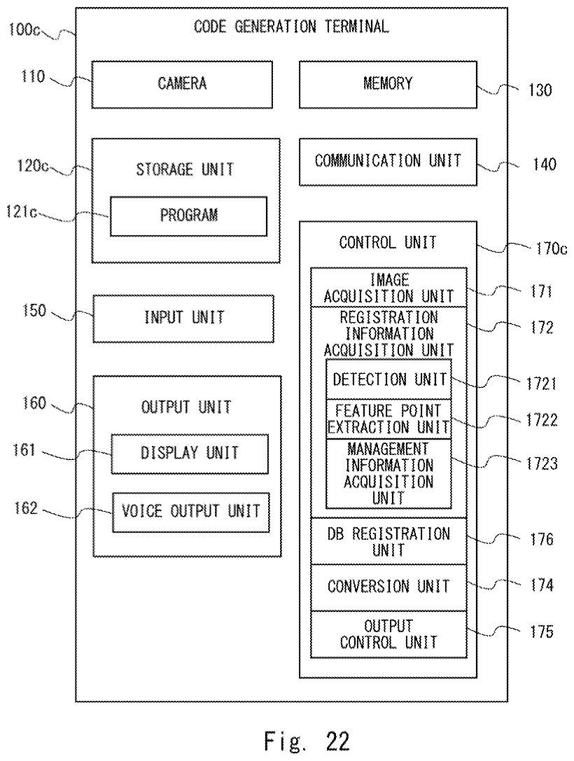

FIG. 22 is a block diagram showing a configuration of the code generation terminal 100c according to the sixth example embodiment. The code generation terminal 100c includes a storage unit 120c and a control unit 170c instead of the storage unit 120 and the control unit 170 of the code generation terminal 100.

The storage unit 120c stores a program 121c in which processing of a code generation method according to the sixth example embodiment is implemented.

The control unit 170c includes, besides the components of the control unit 170, a DB registration unit 176. When the user U is a second user, the DB registration unit 176 registers the face information for registration in association with the user ID in the face information DB 600.

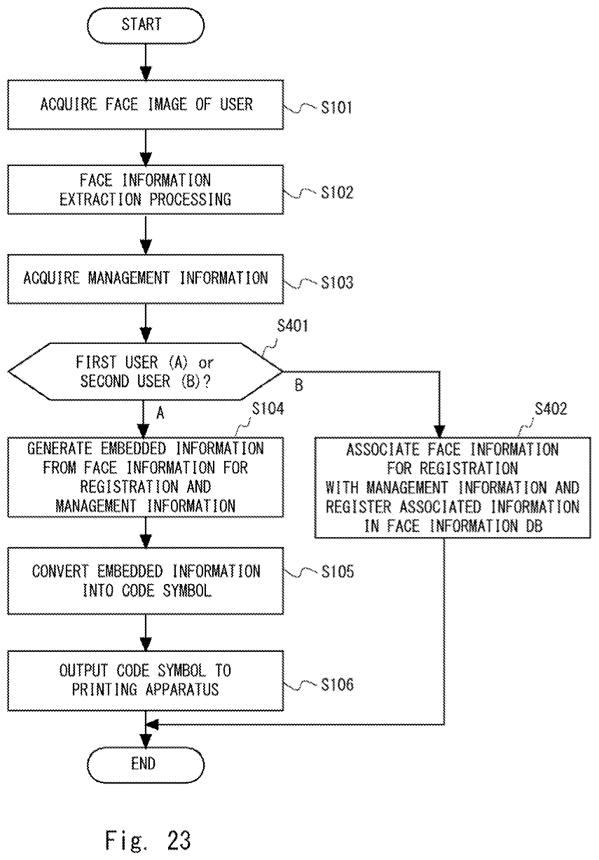

FIG. 23 is a flowchart showing a flow of a code generation method according to the sixth example embodiment. The steps shown in FIG. 23 include, besides the steps shown in FIG. 8, Steps S401 and 402.

In response to the acquisition of the user ID, which is the management information, by the management information acquisition unit 1723 of the registration information acquisition unit 172 via the input unit 150 in Step S103, the control unit 170 determines whether or not the user U is a first user or a second user (S401). The control unit 170 may determine whether or not the user U is the first user or the second user depending on, for example, the type of the user ID. When the user U is a first user (A in Step S401), the processing proceeds to Step S104. Then, like in the second example embodiment, the control unit 170 generates embedded information (S104), converts the embedded information into a code symbol (S105), outputs the code symbol to the printing apparatus 200 (S106), and ends the processing. On the other hand, when the user U is a second user (B in Step S401), the DB registration unit 176 associates the face information for registration with the user ID included in the management information and registers the associated information in the face information DB 600 (S402). Then the DB registration unit 176 ends the processing.

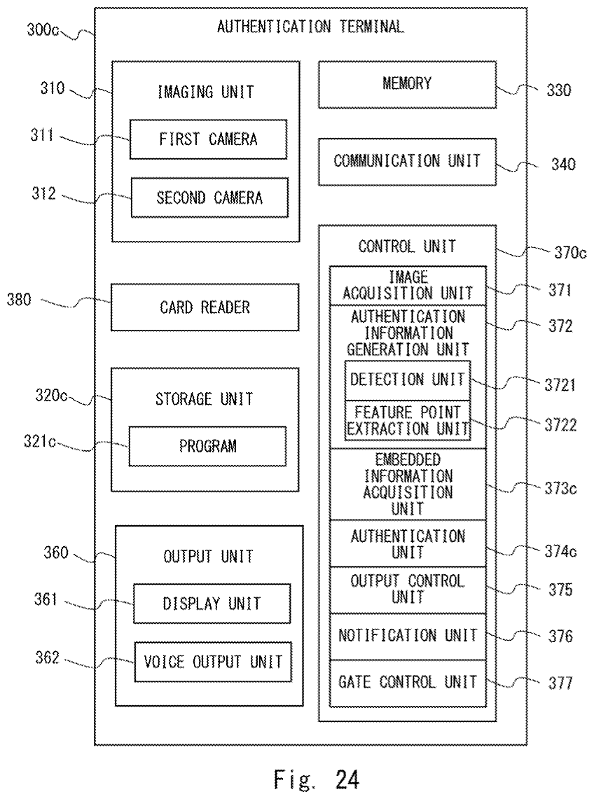

FIG. 24 is a block diagram showing a configuration of the authentication terminal 300c according to the sixth example embodiment. The authentication terminal 300c includes a storage unit 320c, a control unit 370c, and a card reader 380 instead of the storage unit 320 and the control unit 370 of the authentication terminal 300.

The storage unit 320c stores a program 321c in which processing of an authentication method according to the sixth example embodiment is implemented.

The card reader 380 is a card reader that reads management information from an IC card presented by the second user.

The control unit 370c includes an embedded information acquisition unit 373c and an authentication unit 374c instead of the embedded information acquisition unit 373 and the authentication unit 374.

The embedded information acquisition unit 373c includes functions similar to those of the embedded information acquisition unit 373 for the first user. That is, when the user U has presented the code recording medium C and the image acquisition unit 371 has acquired a code image, the embedded information acquisition unit 373c acquires embedded information from the code image, like in the embedded information acquisition unit 373. However, for the second user, the embedded information acquisition unit 373c controls the card reader 380, and acquires management information from the IC card. That is, when the user U has presented the IC card and the image acquisition unit 371 has not acquired the code image, the embedded information acquisition unit 373c controls the card reader 380 and acquires management information from the IC card.

When the embedded information has been acquired from the code image in the embedded information acquisition unit 373, the authentication unit 374c executes processing similar to that performed in the authentication unit 374. On the other hand, when the embedded information acquisition unit 373 has acquired the management information from the IC card, not from a code image, the authentication unit 374c acquires face information for registration that is stored in the face information DB 600 and corresponds to the user ID included in the management information. Then, the authentication unit 374c collates the face information for registration with the face information for authentication generated based on the face image and executes face authentication.

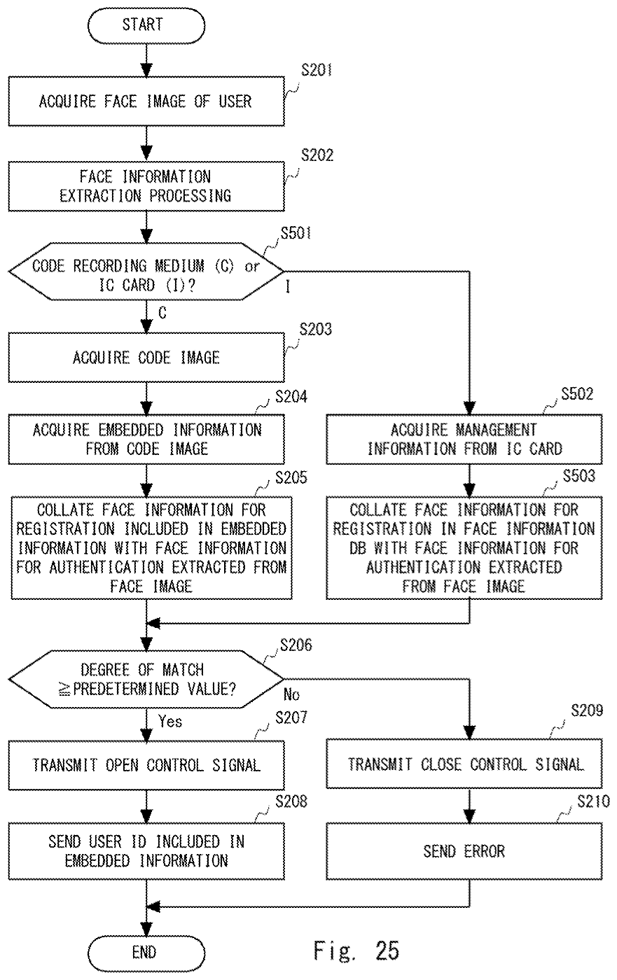

FIG. 25 is a flowchart showing a flow of an authentication method according to the sixth example embodiment. The steps shown in FIG. 25 include, besides the steps shown in FIG. 10, Steps S501 to 503.

After the authentication information generation unit 372 has executed processing for extracting face information from the face image for authentication in Step S202, the embedded information acquisition unit 373c determines whether or not the user U has presented a code recording medium C or has presented an IC card (S501). This determination may be made based on whether or not the image acquisition unit 371 has acquired a code image. When the user U has presented the code recording medium C (C in S501), the embedded information acquisition unit 373c proceeds the processing to Step S203. The processing of Step S203 and the following steps are similar to those shown in FIG. 10. On the other hand, when the user U has presented the IC card (I in S501), the embedded information acquisition unit 373c acquires management information read out by the card reader 380 (S502). Then, the authentication unit 374c acquires the face information for registration that corresponds to the user ID from the face information DB 600 using the user ID included in the management information, and collates the face information for registration with the face information for authentication extracted from the face image in Step S202 (S503). Then, the authentication unit 374c advances processing to Step S206. Step S206 and the following steps are similar to those shown in FIG. 10.

As described above, according to the sixth example embodiment, the authentication system 1000c executes first face authentication using a code recording medium C for the first user and executes second face authentication using a face information DB for the second user. Accordingly, it is possible to selectively use different types of face authentication depending on the target user attributes, and separately manage face authentication histories.

### Seventh Example Embodiment

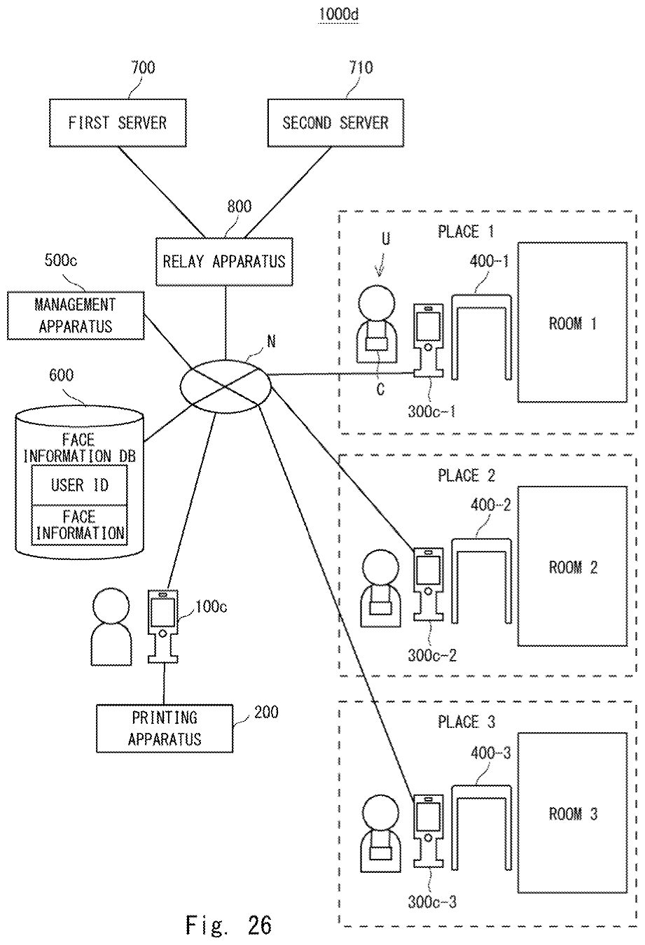

Next, a seventh example embodiment according to the present disclosure will be described. The seventh example embodiment is a modified example of the sixth example embodiment. FIG. 26 is a block diagram showing a whole configuration of an authentication system 1000d according to the seventh example embodiment. The authentication system 1000d includes, besides the components of the authentication system 1000c, a first server 700, a second server 710, and a relay apparatus 800.

The first server 700 is a server computer that manages the labor performed by the first user based on the face authentication history of the first user. For example, the first server 700 is a part-time worker management system that performs attendance record management or salary management of part-time workers based on face authentication histories of part-time workers. The second server 710 is a server computer that manages labor management of the second user based on the face authentication history of the second user. For example, the second server 710 is an employee management system that performs attendance record management or salary management of full-time employees based on face authentication histories of the full-time employees. The first server 700 and the second server 710 are each connected to the relay apparatus 800 in such a way that they can communicate with each other.

The relay apparatus 800 is a server computer that relays data when data is exchanged between the first server 700 and the management apparatus 500c, or data is exchanged between the second server 710 and the management apparatus 500c. The relay apparatus 800 is connected to the network N. The relay apparatus 800 may relay communication, or may temporarily store data received from the transmission source and the destination apparatus may fetch this stored data. While the relay apparatus 800 is installed in order to enhance security levels of the first server 700 and the second server 710, the relay apparatus 800 may not be installed in the authentication system 1000d. When the relay apparatus 800 is not included in the authentication system 1000d, the first server 700 and the second server 710 may be connected to the network N.

When the condition under which the first authentication history 511c is transmitted has been satisfied, the management apparatus 500c transmits the first authentication history 511c stored in the storage unit 510c to the first server 700 via the relay apparatus 800. Alternatively, when the condition under which the first authentication history 511c is transmitted has been satisfied, the management apparatus 500c transmits the first authentication history 511c stored in the storage unit 510c to the relay apparatus 800 to cause the relay apparatus 800 to temporarily store the first authentication history 511c. Further, when the condition under which the second authentication history 512c is transmitted has been satisfied, the management apparatus 500c transmits the second authentication history 512c stored in the storage unit 510c to the second server 710 via the relay apparatus 800. Alternatively, when the condition under which the second authentication history 512c is transmitted has been satisfied, the management apparatus 500c transmits the second authentication history 512c stored in the storage unit 510c to the relay apparatus 800 to cause the relay apparatus 800 to temporarily store the second authentication history 512c. The condition under which each authentication history is transmitted may be a condition that a predetermined period of time has elapsed or may be a condition that an amount of data of the accumulated authentication histories has reached a predetermined amount or larger.

Note that the management apparatus 500c may include a table in which the user ID is associated with the in-house attribute for each of the first user and the second user for face authentication history management. In this case, when personnel changes have been made and the in-house attribute of the first user or the second user has been changed, the first server 700 or the second server 710 may transmit new in-house attribute information in association with the user ID to the management apparatus 500c via the relay apparatus 800. Alternatively, the management apparatus 500c may regularly or irregularly send an inquiry regarding the in-house attribute information that corresponds to the user ID to the first server 700 or the second server 710 via the relay apparatus 800.

As described above, according to the seventh example embodiment, the authentication system 1000d is able to suitably manage the labor record based on the face authentication history for each attribute of the target user.

### Eighth Example Embodiment

Next, an eighth example embodiment of the present disclosure will be described. In the aforementioned seventh example embodiment, one authentication terminal 300c executes face authentication by selectively performing first face authentication or second face authentication. However, in the eighth example embodiment, an authentication terminal that executes first face authentication and an authentication terminal that executes second face authentication are separated from each other.

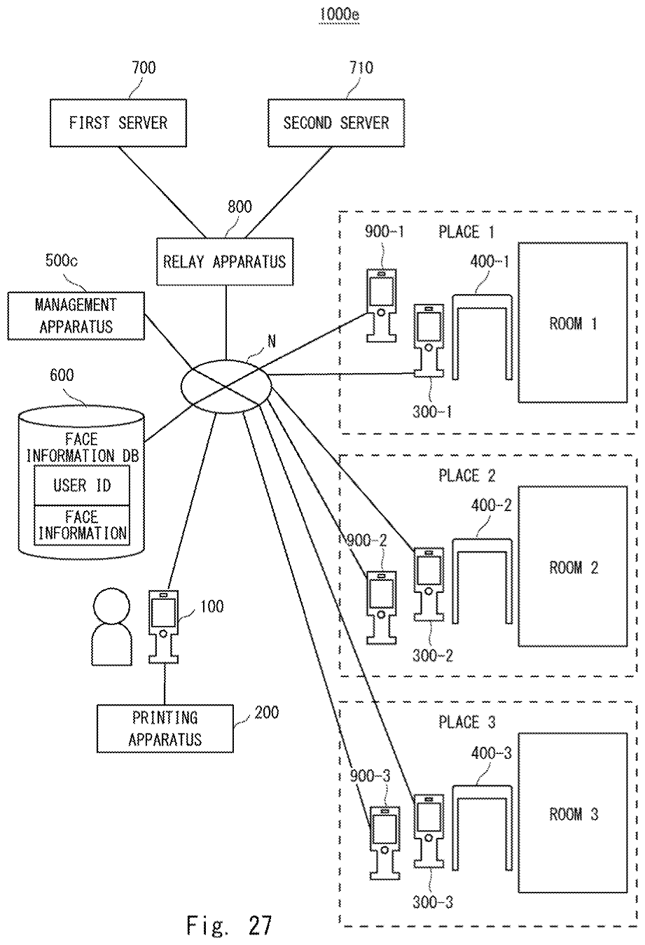

FIG. 27 is a block diagram showing the whole configuration of an authentication system 1000e according to the eighth example embodiment. In the authentication system 1000e, the authentication terminal that executes first face authentication is an authentication terminal according to one of the second to seventh example embodiments. In FIG. 27, it is the authentication terminal 300 according to the second example embodiment. Further, the authentication terminal that executes the second face authentication is an authentication terminal 900 that is different from the authentication terminal 300.

When the user U is a first user, the user U holds the code recording medium C over the authentication terminal 300 and requests for first face authentication. On the other hand, when the user U is a second user, the user U holds the IC card over the authentication terminal 900 and requests for second face authentication.

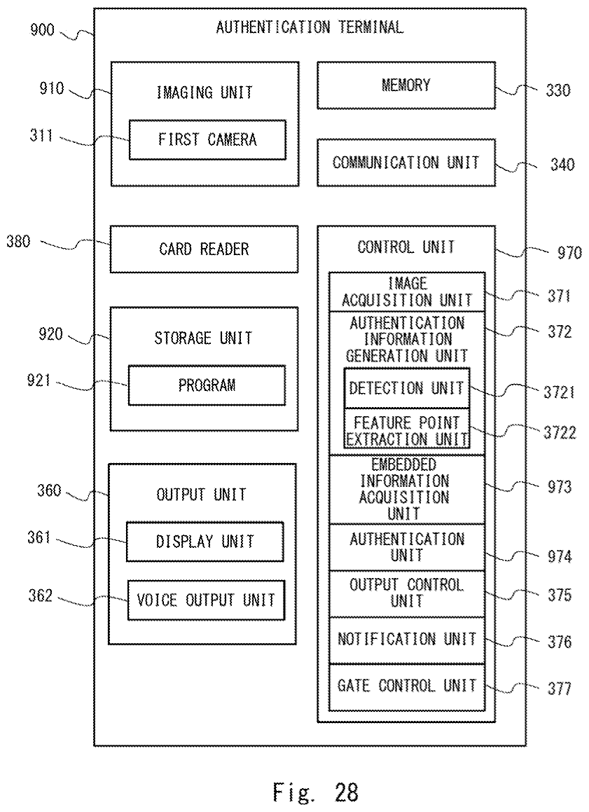

FIG. 28 is a block diagram showing a configuration of an authentication terminal 900 according to the eighth example embodiment. While the configuration of the authentication terminal 900 is basically similar to that of the authentication terminal 300c, the authentication terminal 900 includes an imaging unit 910, a storage unit 920, and a control unit 970 instead of the imaging unit 310, the storage unit 320c, and the control unit 370c.

The imaging unit 910 includes a first camera 311 that captures an image of the face region of the user U. In the imaging unit 910, the second camera 312 that captures an image of the code recording medium C may be omitted.

The storage unit 920 stores a program 921 in which processing according to a method of second face authentication is implemented.

The control unit 970 includes an embedded information acquisition unit 973 and an authentication unit 974 instead of the embedded information acquisition unit 373c and the authentication unit 374c of the control unit 370c. The embedded information acquisition unit 973 may include a function related to the second face authentication of the embedded information acquisition unit 373c, and a function related to the first face authentication may be omitted. Further, the authentication unit 974 may include a function related to the second face authentication of the authentication unit 374c, and a function related to the first face authentication may be omitted.

Note that the present disclosure is not limited to the aforementioned example embodiments and may be changed as appropriate without departing from the spirit of the present disclosure. For example, the above-described second to eighth example embodiments may be combined in a desired manner. For example, the third example embodiment and any one of the fourth to eighth example embodiments may be combined with each other. Further, the fourth example embodiment and any one of the sixth to eighth example embodiments may be combined with each other. Further, the fifth example embodiment and any one of the sixth to eighth example embodiments may be combined with each other.

Further, for example, in the aforementioned second to eighth example embodiments, the imaging unit 310 of each of the authentication terminals 300, 300a, 300b, and 300c includes a first camera 311 and a second camera 312. Alternatively, the imaging unit 310 may be one camera in which the functions of the first camera 311 and the second camera 312 are aggregated.

While the aforementioned example embodiments have been described as a hardware configuration, it is merely an example. The present disclosure may implement desired processing by causing a processor to execute a computer program.

In the aforementioned examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (ROM), CD-R, CD-R/W, Digital Versatile Disc (DVD), and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the example embodiments disclosed above can be described as, but not limited to, the following supplementary notes.

### Supplementary Note A1

An authentication terminal comprising:
image acquisition means for acquiring a body image generated by capturing an image of a body of a target person and a code image generated by capturing an image of a code recording medium, the code recording medium including a code symbol that can be visually recognized and in which embedded information including biometric information for registration of the target person and identification information on the target person are recorded;
embedded information acquisition means for acquiring the embedded information from the code image;
authentication means for executing biometric authentication by collating the biometric information for registration included in the embedded information with biometric information for authentication generated based on the body image; and
notification means for notifying a management apparatus of the identification information on the target person when the biometric authentication has been successful.

### Supplementary Note A2

The authentication terminal according to Supplementary Note A1, comprising gate control means for preventing the target person from passing through a gate when the biometric authentication has failed.

### Supplementary Note A3

The authentication terminal according to Supplementary Note A2, wherein
the embedded information further includes validity period information indicating a validity period, and
the gate control means prevents the target person from passing through the gate when the current date and time are not included in the validity period indicated by the validity period information.

### Supplementary Note A4

The authentication terminal according to Supplementary Note A2 or A3, wherein
the embedded information further includes available place information indicating an available place, and
the gate control means prevents the target person from passing through the gate when the place where the gate is installed is not included in the available place indicated by the available place information.

### Supplementary Note A5

The authentication terminal according to any one of Supplementary Notes A2 to A4, wherein
the embedded information further includes in-house attribute information indicating a type of employment, a department, or a position of the target person, and
the gate control means prevents, when the type of employment, the department, or the position indicated by the in-house attribute information is not a predetermined type of employment, a predetermined department, or a predetermined position, the target person from passing through the gate.

### Supplementary Note A6

The authentication terminal according to any one of Supplementary Notes A1 to A5, comprising output control means for outputting a result of the biometric authentication, wherein
the embedded information further includes nationality-related information related to a nationality of the target person, a national origin of the target person, or a language used by the target person, and
the output control means outputs a result of the biometric authentication in the language according to a nationality or a national origin indicated by the nationality-related information, or a used language indicated by the nationality-related information.

### Supplementary Note A7

The authentication terminal according to any one of Supplementary Notes A1 to A6, wherein the authentication means executes biometric authentication by collating biometric information for registration stored in a database with biometric information for authentication generated based on the body image in a case where the image acquisition means has not acquired the code image.

### Supplementary Note A8

The authentication terminal according to any one of Supplementary Notes A1 to A7, comprising:
a first camera that captures an image of the body of the target person; and
a second camera that captures an image of the code recording medium carried by the target person.

### Supplementary Note A9

The authentication terminal according to Supplementary Note A8, wherein the image acquisition means starts the second camera in accordance with the body image being acquired from the first camera or in accordance with processing for generating the biometric information for authentication being started or completed.

### Supplementary Note A10

A code generation terminal comprising:
registration information acquisition means for acquiring biometric information for registration of a target person from a body image for registration that has been generated by capturing an image of a body of the target person; and
conversion means for converting embedded information including the biometric information for registration of the target person and identification information on the target person into a code symbol that can be visually recognized.

### Supplementary Note A11

The code generation terminal according to Supplementary Note A10, comprising output control means for outputting information on the code symbol to a printing apparatus.

### Supplementary Note A12

An authentication system comprising:
an authentication terminal configured to execute biometric authentication; and
a management apparatus configured to manage a history of the biometric authentication, wherein
the authentication terminal comprises:
   image acquisition means for acquiring a body image generated by capturing an image of a body of a target person and a code image generated by capturing an image of a code recording medium, the code recording medium including a code symbol that can be visually recognized and in which embedded information including biometric information for registration of the target person and identification information on the target person are recorded;
   embedded information acquisition means for acquiring the embedded information from the code image;
   authentication means for executing biometric authentication by collating the biometric information for registration included in the embedded information with biometric information for authentication generated based on the body image; and
   notification means for notifying a management apparatus of the identification information on the target person when the biometric authentication has been successful.

### Supplementary Note A13

The authentication system according to Supplementary Note A12, further comprising a code generation terminal comprising:
registration information acquisition means for acquiring the biometric information for registration of the target person from the body image for registration that has been generated by capturing the image of the body of the target person; and
conversion means for converting embedded information including the biometric information for registration of the target person and identification information on the target person into a code symbol that can be visually recognized.

### Supplementary Note A14

An authentication method comprising:
an image acquisition step of acquiring a body image generated by capturing an image of a body of a target person and a code image generated by capturing an image of a code recording medium, the code recording medium including a code symbol that can be visually recognized and in which embedded information including biometric information for registration of the target person and identification information on the target person are recorded;
an embedded information acquisition step of acquiring the embedded information from the code image;
an authentication step of executing biometric authentication by collating the biometric information for registration included in the embedded information with biometric information for authentication generated based on the body image; and
a notification step of notifying a management apparatus of the identification information on the target person when the biometric authentication has been successful.

### Supplementary Note A15

A non-transitory computer readable medium storing a program for causing a computer to execute:
image acquisition processing for acquiring a body image generated by capturing an image of a body of a target person and a code image generated by capturing an image of a code recording medium, the code recording medium including a code symbol that can be visually recognized and in which embedded information including biometric information for registration of the target person and identification information on the target person are recorded;
embedded information acquisition processing for acquiring the embedded information from the code image;
authentication processing for executing biometric authentication by collating the biometric information for registration included in the embedded information with biometric information for authentication generated based on the body image; and
notification processing for notifying a management apparatus of the identification information on the target person when the biometric authentication has been successful.

### Supplementary Note B1

An authentication terminal comprising:
image acquisition means for acquiring a body image generated by capturing an image of a body of a target person when the target person is in a position located away from imaging means by a first distance and acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded;
authentication information generation means for starting, in accordance with the acquisition of the body image of the target person, processing for generating biometric information for authentication of the target person from the body image;
embedded information acquisition means for acquiring the embedded information from the code image in accordance with the acquisition of the code image;
authentication means for executing biometric authentication by collating the biometric information for authentication with the biometric information for registration included in the embedded information; and
gate control means for preventing the target person from passing through a gate when the biometric authentication has failed.

### Supplementary Note B2

The authentication terminal according to Supplementary Note B1, wherein
the imaging means includes a first camera and a second camera,
the first camera captures an image of the body of the target person, and
the second camera captures an image of the code recording medium carried by the target person.

### Supplementary Note B3

The authentication terminal according to Supplementary Note B2, wherein the image acquisition means starts the second camera in accordance with the body image being acquired from the first camera or in accordance with the authentication information generation means starting or completing processing for generating the biometric information for authentication.

### Supplementary Note B4

The authentication terminal according to any one of Supplementary Notes B1 to B3, wherein a second angle of view in a case where an image of the code recording medium is captured is wider than a first angle of view in a case where an image of the body of the target person is captured.

### Supplementary Note B5

The authentication terminal according to any one of Supplementary Notes B1 to B4, wherein
the body is a face, and
the authentication information generation means generates the biometric information for authentication of the target person from the body image when the size or the length of a face region of the target person included in the body image is equal to or larger than a predetermined number of pixels, or when a length of the line connecting predetermined face organs included in the face region of the target person is equal to or larger than a predetermined number of pixels.

### Supplementary Note B6

The authentication terminal according to any one of Supplementary Notes B1 to B5, wherein the authentication information generation means determines whether or not the target person is approaching the imaging means in response to the start of the processing for generating the biometric information for authentication of the target person.

### Supplementary Note B7

The authentication terminal according to Supplementary Note B6, wherein the authentication means executes the biometric authentication when it is determined that the target person is approaching the imaging means.

### Supplementary Note B8

The authentication terminal according to any one of Supplementary Notes B1 to B7, wherein
the image acquisition means acquires a plurality of body images generated by capturing an image of the body of the target person a plurality of times, and
the authentication information generation means generates the biometric information for authentication of the target person from at least one of the plurality of body images.

### Supplementary Note B9

The authentication terminal according to Supplementary Note B8, wherein
the authentication information generation means calculates, for each of the plurality of body images, an index of a degree of certainty of an identification of a body, and
the authentication information generation means selects the at least one of the plurality of body images based on the index.

### Supplementary Note B10

The authentication terminal according to any one of Supplementary Notes B1 to B7, wherein
the image acquisition means acquires a plurality of body images generated by capturing an image of the body of the target person a plurality of times, and
the authentication information generation means generates, for each of the plurality of body images, biometric information for authentication of the target person.

### Supplementary Note B11

The authentication terminal according to any one of Supplementary Notes B1 to B10, wherein
the authentication information generation means calculates, for the body image, an index of a degree of certainty of an identification of a body, and
the authentication information generation means generates the biometric information for authentication of the target person when the index is equal to or larger than a predetermined threshold.

### Supplementary Note B12

The authentication terminal according to any one of Supplementary Notes B1 to B11, further comprising notification means for notifying a management apparatus of the identification information on the target person when the biometric authentication has been successful.

### Supplementary Note B13

An authentication system comprising an authentication terminal comprising:
image acquisition means for acquiring a body image generated by capturing an image of a body of a target person when the target person is in a position located away from imaging means by a first distance and acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded;
authentication information generation means for starting, in accordance with the acquisition of the body image of the target person, processing for generating biometric information for authentication of the target person from the body image;
embedded information acquisition means for acquiring the embedded information from the code image in accordance with the acquisition of the code image;
authentication means for executing biometric authentication by collating the biometric information for authentication with the biometric information for registration included in the embedded information; and
gate control means for preventing the target person from passing through a gate when the biometric authentication has failed.

### Supplementary Note B14

The authentication system according to Supplementary Note B13, further comprising a code generation terminal comprising:
registration information acquisition means for acquiring the biometric information for registration of the target person from the body image for registration that has been generated by capturing the image of the body of the target person; and
conversion means for converting the embedded information including the biometric information for registration of the target person into a code symbol that can be visually recognized.

### Supplementary Note B15

The authentication system according to Supplementary Note B13 or B14, further comprising a management apparatus configured to manage a history of the biometric authentication, wherein
the embedded information further includes identification information on the target person, and
the authentication terminal further includes notification means for notifying a management apparatus of the identification information on the target person included in the embedded information when the biometric authentication has been successful.

### Supplementary Note B16

An authentication method comprising:
a first image acquisition step of acquiring a body image generated by capturing an image of a body of a target person when the target person is in a position located away from imaging means by a first distance;
an authentication information generation step of starting processing for generating biometric information for authentication of the target person from the body image in accordance with the acquisition of the body image of the target person;
a second image acquisition step of acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded;
an embedded information acquisition step of acquiring the embedded information from the code image in accordance with the acquisition of the code image;
an authentication step of executing biometric authentication by collating the biometric information for authentication with the biometric information for registration included in the embedded information; and
a gate control step of preventing the target person from passing through a gate when the biometric authentication has failed.

### Supplementary Note B17

A non-transitory computer readable medium storing a program for causing a computer to execute:
first image acquisition processing for acquiring a body image generated by capturing an image of a body of a target person when the target person is in a position located away from imaging means by a first distance;
authentication information generation processing for starting, in accordance with the acquisition of the body image of the target person, processing for generating biometric information for authentication of the target person from the body image;
second image acquisition processing for acquiring a code image generated by capturing an image of a code recording medium carried by the target person when the target person is in a position located away from the imaging means by a second distance which is shorter than the first distance, the code recording medium including a code symbol that can be visually recognized and in which embedded information including biometric information for registration of the target person is recorded;
embedded information acquisition processing for acquiring the embedded information from the code image in accordance with the acquisition of the code image;
authentication processing for executing biometric authentication by collating the biometric information for authentication with the biometric information for registration included in the embedded information; and
gate control processing for preventing the target person from passing through a gate when the biometric authentication has failed.

### Supplementary Note C1

An authentication terminal comprising:
a first camera configured to capture an image of a body of a target person;
a second camera that captures an image of the code recording medium carried by the target person, the code recording medium including a code symbol that can be visually recognized and in which embedded information including biometric information for registration of the target person is recorded;
image acquisition means for acquiring a body image generated by capturing an image of the body of the target person by the first camera and a code image generated by capturing an image of the code recording medium by the second camera;
authentication information generation means for starting, in accordance with the acquisition of the body image of the target person, processing for generating biometric information for authentication of the target person from the body image;
embedded information acquisition means for acquiring the embedded information from the code image in accordance with the acquisition of the code image;
authentication means for executing biometric authentication by collating the biometric information for authentication with the biometric information for registration included in the embedded information; and
gate control means for preventing the target person from passing through a gate when the biometric authentication has failed.

### Supplementary Note C2

The authentication terminal according to Supplementary Note C1, wherein the first camera and the second camera are disposed in different positions on a main surface of the authentication terminal.

### Supplementary Note C3

The authentication terminal according to Supplementary Note C1 or C2, wherein the image acquisition means starts the second camera in accordance with the body image being acquired from the first camera or in accordance with the authentication information generation means starting or completing processing for generating the biometric information for authentication.

### Supplementary Note C4

The authentication terminal according to any one of Supplementary Notes C1 to C3, wherein a second angle of view of the second camera is wider than a first angle of view of the first camera.

### Supplementary Note C5

The authentication terminal according to any one of Supplementary Notes C1 to C4, wherein
the body is a face, and
the authentication information generation means generates the biometric information for authentication of the target person from the body image when the size or the length of a face region of the target person included in the body image is equal to or larger than a predetermined number of pixels, or when a length of the line connecting predetermined face organs included in the face region of the target person is equal to or larger than a predetermined number of pixels.

### Supplementary Note C6

The authentication terminal according to any one of Supplementary Notes C1 to C5, wherein the authentication information generation means determines whether or not the target person is approaching the first camera in response to the start of the processing for generating the biometric information for authentication of the target person.

### Supplementary Note C7

The authentication terminal according to Supplementary Note C6, wherein the authentication means executes the biometric authentication when it is determined that the target person is approaching the first camera.

### Supplementary Note C8

The authentication terminal according to any one of Supplementary Notes C1 to C7, wherein
the image acquisition means acquires a plurality of body images generated by capturing an image of the body of the target person a plurality of times, and
the authentication information generation means generates the biometric information for authentication of the target person from at least one of the plurality of body images.

### Supplementary Note C9

The authentication terminal according to Supplementary Note C8, wherein the authentication information generation means calculates, for each of the plurality of body images, an index of a degree of certainty of an identification of a body, and
the authentication information generation means selects the at least one of the plurality of body images based on the index.

### Supplementary Note C10

The authentication terminal according to any one of Supplementary Notes C1 to C7, wherein
the image acquisition means acquires a plurality of body images generated by capturing an image of the body of the target person a plurality of times, and
the authentication information generation means generates, for each of the plurality of body images, biometric information for authentication of the target person.

### Supplementary Note C11

The authentication terminal according to any one of Supplementary Notes C1 to C10, wherein
the authentication information generation means calculates, for the body image, an index of a degree of certainty of an identification of a body, and
the authentication information generation means generates the biometric information for authentication of the target person when the index is equal to or larger than a predetermined threshold.

### Supplementary Note C12

The authentication terminal according to any one of Supplementary Notes C1 to C11, further comprising notification means for notifying a management apparatus of the identification information on the target person when the biometric authentication has been successful.

### Supplementary Note C13

An authentication system comprising an authentication terminal comprising:
a first camera configured to capture an image of a body of a target person;
a second camera that captures an image of the code recording medium carried by the target person, the code recording medium including a code symbol that can be visually recognized and in which embedded information including biometric information for registration of the target person is recorded;
image acquisition means for acquiring a body image generated by capturing an image of the body of the target person by the first camera and a code image generated by capturing an image of the code recording medium by the second camera;
authentication information generation means for starting, in accordance with the acquisition of the body image of the target person, processing for generating biometric information for authentication of the target person from the body image;
embedded information acquisition means for acquiring the embedded information from the code image in accordance with the acquisition of the code image;
authentication means for executing biometric authentication by collating the biometric information for authentication with the biometric information for registration included in the embedded information; and
gate control means for preventing the target person from passing through a gate when the biometric authentication has failed.

### Supplementary Note C14

The authentication system according to Supplementary Note C13, further comprising a code generation terminal comprising:
registration information acquisition means for acquiring the biometric information for registration of the target person from the body image for registration that has been generated by capturing the image of the body of the target person; and
conversion means for converting the embedded information including the biometric information for registration of the target person into a code symbol that can be visually recognized.

### Supplementary Note C15

The authentication system according to Supplementary Note C13 or C14, further comprising a management apparatus configured to manage a history of the biometric authentication, wherein
the embedded information further includes identification information on the target person, and
the authentication terminal further includes notification means for notifying a management apparatus of the identification information on the target person included in the embedded information when the biometric authentication has been successful.

### Supplementary Note C16

An authentication method comprising:
a first image acquisition step of acquiring a body image generated by capturing an image of a body of a target person by a first camera;
an authentication information generation step of starting processing for generating biometric information for authentication of the target person from the body image in accordance with the acquisition of the body image of the target person;
a second image acquisition step of acquiring a code image generated by capturing an image of a code recording medium carried by the target person by a second camera, the code recording medium including a code symbol that can be visually recognized and in which embedded information including biometric information for registration of the target person is recorded;
an embedded information acquisition step of acquiring the embedded information from the code image in accordance with the acquisition of the code image;
an authentication step of executing biometric authentication by collating the biometric information for authentication with the biometric information for registration included in the embedded information; and
a gate control step of preventing the target person from passing through a gate when the biometric authentication has failed.

### Supplementary Note C17

A non-transitory computer readable medium storing a program for causing a computer to execute:
first image acquisition processing for acquiring a body image generated by capturing an image of a body of a target person by a first camera;
authentication information generation processing for starting, in accordance with the acquisition of the body image of the target person, processing for generating biometric information for authentication of the target person from the body image;
second image acquisition processing for acquiring a code image generated by capturing an image of a code recording medium carried by the target person by a second camera, the code recording medium including a code symbol that can be visually recognized and in which embedded information including biometric information for registration of the target person is recorded;
embedded information acquisition processing for acquiring the embedded information from the code image in accordance with the acquisition of the code image;
authentication processing for executing biometric authentication by collating the biometric information for authentication with the biometric information for registration included in the embedded information; and gate control processing for preventing the target person from passing through a gate when the biometric authentication has failed.

### REFERENCE SIGNS LIST

10 AUTHENTICATION TERMINAL
11 IMAGE ACQUISITION UNIT
12 AUTHENTICATION INFORMATION GENERATION UNIT
13 EMBEDDED INFORMATION ACQUISITION UNIT
14 AUTHENTICATION UNIT
17 GATE CONTROL UNIT
100, 100C CODE GENERATION TERMINAL
110 CAMERA
120, 120C STORAGE UNIT
121, 121C PROGRAM
130 MEMORY
140 COMMUNICATION UNIT
150 INPUT UNIT
160 OUTPUT UNIT
161 DISPLAY UNIT
162 VOICE OUTPUT UNIT
170, 170C CONTROL UNIT
171 IMAGE ACQUISITION UNIT
172 REGISTRATION INFORMATION ACQUISITION UNIT
1721 DETECTION UNIT
1722 FEATURE POINT EXTRACTION UNIT
1723 MANAGEMENT INFORMATION ACQUISITION UNIT
174 CONVERSION UNIT
175 OUTPUT CONTROL UNIT
176 DB REGISTRATION UNIT
200 PRINTING APPARATUS
300, 300A, 300B, 300C AUTHENTICATION TERMINAL
310 IMAGING UNIT
311 FIRST CAMERA
312 SECOND CAMERA
320, 320A, 320B, 320C STORAGE UNIT
321, 321A, 321B, 321C PROGRAM
322 PREVENTION CONDITION INFORMATION
323 LANGUAGE TABLE
330 MEMORY
340 COMMUNICATION UNIT
360 OUTPUT UNIT
361 DISPLAY UNIT
362 VOICE OUTPUT UNIT
370, 370A, 370B, 370C CONTROL UNIT
371 IMAGE ACQUISITION UNIT
372 AUTHENTICATION INFORMATION GENERATION UNIT
3721 DETECTION UNIT
3722 FEATURE POINT EXTRACTION UNIT
373 EMBEDDED INFORMATION ACQUISITION UNIT
374, 374A, 374C AUTHENTICATION UNIT
375, 375B OUTPUT CONTROL UNIT
376 NOTIFICATION UNIT
377 GATE CONTROL UNIT
380 CARD READER
400 GATE
500, 500C MANAGEMENT APPARATUS
510 STORAGE UNIT
511 AUTHENTICATION HISTORY
511C FIRST AUTHENTICATION HISTORY
5111, 5121 USER ID
5112, 5122 DATE AND TIME
5113, 5123 GATE ID
512C SECOND AUTHENTICATION HISTORY
520 COMMUNICATION UNIT
530 CONTROL UNIT
600 FACE INFORMATION DATABASE
700 FIRST SERVER
710 SECOND SERVER
800 RELAY APPARATUS
900 AUTHENTICATION TERMINAL
910 IMAGING UNIT
920 STORAGE UNIT
921 PROGRAM
970 CONTROL UNIT
973 EMBEDDED INFORMATION ACQUISITION UNIT
974 AUTHENTICATION UNIT
1000, 1000C, 1000D, 1000E AUTHENTICATION SYSTEM
N NETWORK
U USER
CV CAPTURE VOLUME
Θ ANGLE OF VIEW
P POSITION
I IMAGE

What is claimed is:

1. An authentication terminal comprising:
at least one memory storing instructions, and
at least one processor configured to execute the instructions to;
acquire a body image generated by capturing an image of a body of a target person when the target person is in a position located away from an imaging device by a first distance and acquire a code image generated by capturing an image of a code recording medium carried by the target person when the target person is in a position located away from the imaging device by a second distance which is shorter than the first distance, the code recording medium including a code symbol that can be visually recognized and in which embedded information including biometric information for registration of the target person is recorded;
start, in accordance with the acquisition of the body image of the target person, processing for generating biometric information for authentication of the target person from the body image;
acquire the embedded information from the code image in accordance with the acquisition of the code image;
execute biometric authentication by collating the biometric information for authentication with the biometric information for registration included in the embedded information; and
control a gate to prevent the target person from passing through the gate when the biometric authentication has failed.

2. The authentication terminal according to claim 1, wherein
the imaging device includes a first camera and a second camera,
the first camera captures an image of the body of the target person, and
the second camera captures an image of the code recording medium carried by the target person.

3. The authentication terminal according to claim 2, wherein at least one processor is configured to execute the instructions to start the second camera in accordance with the body image being acquired from the first camera or in accordance with processing for generating the biometric information for authentication being started or completed.

4. The authentication terminal according to claim 1, wherein a second angle of view in a case where an image of the code recording medium is captured is wider than a first angle of view in a case where an image of the body of the target person is captured.

5. The authentication terminal according to claim 1, wherein
the body is a face, and
at least one processor is configured to execute the instructions to generate the biometric information for authentication of the target person from the body image when the size or the length of a face region of the target person included in the body image is equal to or larger than a predetermined number of pixels, or when a length of the line connecting feature points of a predetermined face organ included in the face region of the target person is equal to or larger than a predetermined number of pixels.

6. The authentication terminal according to claim 1, wherein at least one processor is configured to execute the instructions to determine whether or not the target person is approaching the imaging device in response to the start of the processing for generating the biometric information for authentication of the target person.

7. The authentication terminal according to claim 6, wherein at least one processor is configured to execute the instructions to execute the biometric authentication when it is determined that the target person is approaching the imaging device.

8. An authentication system comprising an authentication terminal comprising:
at least one memory storing instructions, and
at least one processor configured to execute the instructions to;
acquire a body image generated by capturing an image of a body of a target person when the target person is in a position located away from a imaging device by a first distance and acquire a code image generated by capturing an image of a code recording medium carried by the target person when the target person is in a position located away from the imaging device by a second distance which is shorter than the first distance, the code recording medium including a code symbol that can be visually recognized and in which embedded information including biometric information for registration of the target person is recorded;
start, in accordance with the acquisition of the body image of the target person, processing for generating biometric information for authentication of the target person from the body image;
acquire the embedded information from the code image in accordance with the acquisition of the code image;
execute biometric authentication by collating the biometric information for authentication with the biometric information for registration included in the embedded information; and
control a gate to prevent the target person from passing through the gate when the biometric authentication has failed.

9. The authentication system according to claim 8, further comprising a code generation terminal comprising:
at least one memory storing instructions, and
at least one processor configured to execute the instructions to;
acquire the biometric information for registration of the target person from the body image for registration that has been generated by capturing the image of the body of the target person; and
convert the embedded information including the biometric information for registration of the target person into a code symbol that can be visually recognized.

10. (canceled)

11. A non-transitory computer readable medium storing a program for causing a computer to execute
acquiring a body image generated by capturing an image of a body of a target person when the target person is in a position located away from an imaging device by a first distance;
starting, in accordance with the acquisition of the body image of the target person, processing for generating biometric information for authentication of the target person from the body image;
acquiring a code image generated by capturing an image of a code recording medium carried by the target person when the target person is in a position located away from the imaging device by a second distance which is shorter than the first distance, the code recording medium including a code symbol that can be visually recognized and in which embedded information including biometric information for registration of the target person is recorded;
acquiring the embedded information from the code image in accordance with the acquisition of the code image;
executing biometric authentication by collating the biometric information for authentication with the biometric information for registration included in the embedded information; and
controlling a gate to prevent the target person from passing through the gate when the biometric authentication has failed.
